(19) United States
(12) Patent Application Publication
(10) Pub. No.: US 2009/0067046 A1
(43) Pub. Date: Mar. 12, 2009

(54) ANTIREFLECTION FILM, POLARIZING PLATE AND IMAGE DISPLAY

(76) Inventors: Masaki Noro, Kanagawa (JP); Hiroyuki Yoneyama, Kanagawa (JP)

Correspondence Address: BIRCH STEWART KOLASCH & BIRCH, PO BOX 747, FALLS CHURCH, VA, 22040-0747, US

(21) Appl. No.: 11/913,172

(22) PCT Filed: Jun. 27, 2006
(86) PCT No.: PCT/JP2006/313181

§ 371 Date: Oct. 30, 2007

(30) Foreign Application Priority Data
Jun. 27, 2005 (JP) 2005-186934

(51) Int. Cl. G02B 1/11; C08L 27/14

(52) U.S. Cl. 359/485; 525/104

(57) ABSTRACT

An antireflection film is provided and includes, as an outermost layer, a lower refractive index layer containing a fluorine-containing polymer of which a main chain is formed solely of carbon atoms and a compound having a polysiloxane structure. The fluorine-containing polymer contains a hydroxyl group-containing vinyl monomeric polymerization unit with a content exceeding 20 mole %.

### TECHNICAL FIELD

The present invention relates to an antireflection film, a polarizing plate utilizing the antireflection film, and an image display utilizing the antireflection film or the polarizing plate in an outermost surface of the display.

### BACKGROUND ART

An antireflection film is generally employed in a display such as a cathode ray tube display (CRT), a plasma display panel (PDP), an electroluminescent display (ELD) or a liquid crystal display (LCD), on an outermost surface of such display in order to reduce a reflectance utilizing principle of an optical interference, thereby preventing a loss in image contrast by a reflection of an external light or preventing a reflection of an external scene.

In general, such antireflection film can be prepared by forming, on a substrate, a lower refractive index layer having an appropriate thickness and a refractive index lower than that of the substrate. The lower refractive index layer is required to have a refractive index as low as possible in order to realize a low reflectance. Also the antireflection film is required to have a high scratch resistance, as it is used in the outermost surface of the display. In order to realize a high scratch resistance in a thin film with a thickness of about 100 nm, a strength of the film itself and an adhesion to the underlying layer are necessary.

For reducing the refractive index of a material, there are known methods of (1) introducing a fluorine atom, and (2) reducing a density (introducing cavities), but these methods tend to deteriorate the film strength and the interfacial adhesion, thereby reducing the scratch resistance, and it has been difficult to achieve a lower refractive index and a high scratch resistance at the same time. Also as the antireflection film is used on the outermost surface of the display or the like, it is required that a sticking stain can be easily wiped off, and an improvement in the stain resistance is another target.

For improving the film strength by a certain extent, JP-A-2002-265866 and JP-A-2002-317152 propose technologies of utilizing a fluorine-containing sol/gel film.

Japanese Patent No. 3498381 and JP-A-2003-26732 propose technologies of forming a lower refractive index layer by coating a fluorine-containing polymer, followed by a curing.

On the other hand, JP-A-11-189621, JP-A-11-228631 and JP-A-2000-313709 propose technologies of improving the scratch resistance, by introducing a polysiloxane structure into a fluorine-containing polymer.

Also JP-A-2004-307524 proposes a technology of introducing a polysiloxane structure into a fluorine-containing polymer and increasing a content of hydroxyl groups.

The technologies of JP-A-2002-265866 and JP-A-2002-317152 involve significant limitations such as (1) requiring a prolonged heating time for curing, thus giving rise to a significant burden in the manufacture, and (2) being unable to execute a saponification, in case it is required on a surface of the transparent substrate of the antireflection film, after the formation of the antireflection film, due to the lack of resistance thereof to a saponifying solution (alkali processing solution).

A film prepared with the technologies of Japanese Patent No. 3498381 and JP-A-2003-26732 certainly has a lower refractive index, but is insufficient in the scratch resistance.

The technologies of JP-A-11-189621, JP-A-11-228631 and JP-A-2000-313709 allow to reduce the friction coefficient on the film surface, thus being effective to a certain extent in improving the scratch resistance, but are unable to provide a sufficient scratch resistance in case of a film that is inherently insufficient in the film strength and in the interfacial adhesion.

JP-A-2004-307524 discloses that the scratch resistance can be improved by the proposed technology, but is still unable to provide a sufficient scratch resistance.

Furthermore, the polymers described in Japanese Patent No. 3498381 JP-A-11-189621, JP-A-11-228631, JP-A-2000-313709 and JP-A-2004-307524 require a polymerization time as long as 20 hours, and thus the productivity is low. The stain resistance is improved to a certain extent by the introduction of a polysiloxane structure, but still remains in a level requiring a further improvement.

### DISCLOSURE OF THE INVENTION

An object of an illustrative, non-limiting embodiment of the present invention is to provide an antireflection film realizing a sufficient antireflective property and also improved in the scratch resistance and the stain resistance, and also to provide a polarizing plate and an image display utilizing such antireflection film.

As a result of intensive investigations undertaken by the present inventors, it is found that a lower refractive index layer, containing a fluorine-containing polymer having a specified structure and a compound having a polysiloxane structure, can provide an antireflection film excellent in the scratch resistance and the stain resistance.

An aspect of the present invention provides an antireflection film, a polarizing plate and an image display of following constitutions, thereby accomplishing the aforementioned objects.

(1) An antireflection film including: a transparent substrate; and a lower refractive index layer containing a fluorine-containing polymer having a main chain of carbon atoms only and a compound having a polysiloxane structure. The fluorine-containing polymer contains a fluorine-containing vinyl monomeric polymerization unit (a first polymerization unit derived from a fluorine-containing vinyl monomer) and a hydroxyl group-containing vinyl monomeric polymerization unit (a second polymerization unit derived from a hydroxyl group-containing monomer). and a content of the hydroxyl group-containing vinyl monomer polymerization unit exceeds 20 mole % with respect to the fluorine-containing polymer.

(2) An antireflection film according to (1) above, wherein the fluorine-containing polymer is represented by formula (1):

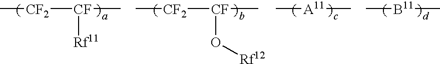

In the formula (1), Rf¹¹ represents a perfluoroalkyl group containing 1 to 5 carbon atoms; Rf¹² represents a fluorine-containing alkyl group containing 1 to 30 carbon atoms; A¹¹ represents a hydroxyl group-containing vinyl monomeric polymerization unit; B¹¹ represents an arbitrary constituent unit; and a to d respectively represent molar ratios (%) of the constituents, with values satisfying relations of 30≦a≦70, 0≦b≦40, 20<c≦70 and 0≦d≦40.

(3) An antireflection film according to (1) or (2) above, wherein the lower refractive index layer further comprises a crosslinking agent capable of reacting with a hydroxyl group.

(4) An antireflection film according to any one of (1) to (3) above, wherein the compound having the polysiloxane structure further contains at least one of a hydroxyl group, a functional group capable of forming a bond by reacting with a hydroxyl group, and a functional group capable of forming a bond by reacting with the crosslinking agent.

(5) An antireflection film according to (4) above, wherein the crosslinking agent is a compound containing a nitrogen atom in a molecule thereof and having two or more carbon atoms, each of the two or more carbon atoms being adjacent to the nitrogen atom and being substituted with an alkoxy group.

(6) A polarizing plate including an antireflection film according to any one of (1) to (5) above, as one of two protective films for a polarizer of the polarizing plate.

(7) An image display including an antireflection film according to any one of (1) to (5) above or a polarizing plate according to (6) above, in an outermost surface of the display.

An antireflection film according to an aspect of the present invention, while having a sufficient antireflective property, is excellent in the scratch resistance and in the stain resistance. Also the image display equipped with the antireflection film, and the image display equipped with a polarizing plate utilizing the antireflection film shows little reflection of an external light or an external scene, thus providing an extremely high visibility.

### BRIEF DESCRIPTION OF THE DRAWINGS

FIG. 1A is a schematic cross-sectional view showing a layered structured of an exemplary embodiment of an antireflection film of the invention.

FIG. 1B is a schematic cross-sectional view showing a layered structured of another exemplary embodiment of an antireflection film of the invention.

### DETAILED DESCRIPTION OF THE INVENTION

In the following, exemplary embodiments of the present invention will be explained in detail. In the present specification, when a numerical value is used for representing a physical property or characteristics, an expression “(numerical value 1) to (numerical value 2)” means a value equal to or larger than (numerical value 1) but equal to or smaller than (numerical value 2). Also an expression “on the substrate” as used herein indicates both a surface of the substrate itself and a surface of a layer (or film) provided on the substrate.

<Antireflection Film>

In the following, a basic structure of the antireflection film as a preferred embodiment of the invention will be explained with reference to the accompanying drawings.

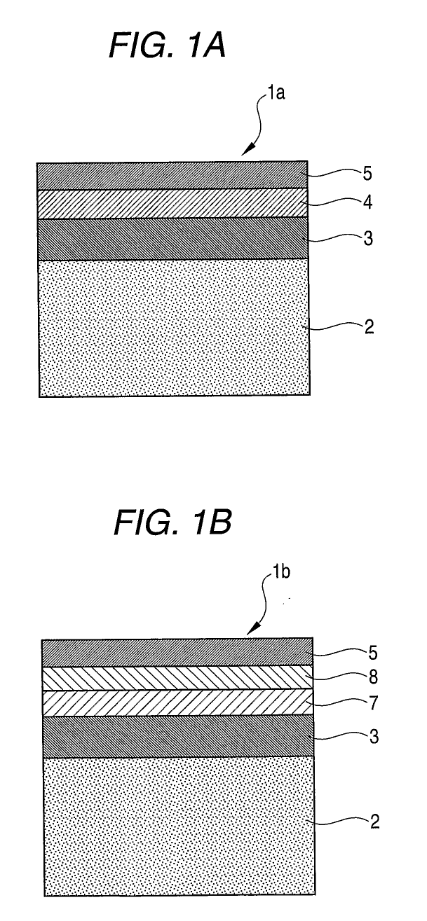

FIG. 1A is a schematic cross-sectional view showing an antireflection film 1a of an exemplary embodiment of the invention, which has a layered structure in an order of a transparent substrate 2, a hard coat layer 3, an antiglare hard coat layer 4, and a lower refractive index layer 5.

The antiglare hard coat layer 4 contains matting particles (not shown) dispersed therein, and preferably has, in a material other than the matting particles, a refractive index within a range of 1.48 to 2.00, and the lower refractive index layer 5 preferably has a refractive index within a range of 1.20 to 1.47.

In the present invention, the hard coat layer may be such hard coat layer having an antiglare property or a hard coat layer without an antiglare property, and may be formed by a single layer or by plural layers, for example 2 to 4 layers. Otherwise, the antireflection film may have no hard coat layer. Thus the hard coat layer 3 and the antiglare hard coat layer 4 shown in FIG. 1A are not indispensable, but at least either of these hard coat layers is preferably provided in order to provide the film with a strength. The lower refractive index layer is coated as an outermost layer.

FIG. 1B is a schematic cross-sectional view showing an antireflection film 1b of another exemplary embodiment of the invention, which has a layered structure in an order of a transparent substrate 2, a hard coat layer 3, a medium refractive index layer 7, a higher refractive index layer 8, and a lower refractive index layer (outermost layer) 5. The transparent substrate 2, the medium refractive index layer 7, the higher refractive index layer 8 and the lower refractive index layer 5 have refractive indexes satisfying the following relationship:

refractive index of higher refractive index layer>refractive index of medium refractive index layer>refractive index of transparent substrate>refractive index of lower refractive index layer

In the layered structure as shown in FIG. 1B, it is preferable, as described in JP-A-59-50401, that the medium refractive index layer, the higher refractive index layer and the lower refractive index layer respectively satisfy conditions of following relations (1), (2), and (3), in order to obtain an antireflection film of a better antireflective property:

(hλ/4)×0.7<n₁d₁<(hλ/4)×1.3 relation (1)

In the relation (1), h is a positive integer (generally 1, 2 or 3); n₁ represents a refractive index of the medium refractive index layer; d₁ represents a thickness (nm) of the medium refractive index layer; and λ represents a wavelength (nm) of a visible light, within a range of from 380 to 680 nm.

(iλ/4)×0.7<n₂d₂<(iλ/4)×1.3 relation (2)

In the relation (2), i is a positive integer (generally 1, 2 or 3); n₂ represents a refractive index of the higher refractive index layer; d₂ represents a thickness (nm) of the higher refractive index layer; and λ represents a wavelength (nm) of a visible light, within a range of from 380 to 680 nm.

(jλ/4)×0.7<n₃d₃<(jλ/4)×1.3 relation (3)

In the relation (3), j is a positive odd number (generally 1); n₃ represents a refractive index of the lower refractive index layer; d₃ represents a thickness (nm) of the lower refractive index layer; and λ represents a wavelength (nm) of a visible light, within a range of from 380 to 680 nm.

In the layered structure as shown in FIG. 1B, it is particularly preferable that the medium refractive index layer, the higher refractive index layer and the lower refractive index layer respectively satisfy conditions of following relations (1-1), (2-1), and (3-1), in which λ=500 nm, h=1, i=2 and j=1.

(hλ/4)×0.80<n₁d₁<(hλ/4)×1.00 relation (1-1)

(iλ/4)×0.75<n₂d₂<(iλ/4)×0.95 relation (2-1)

(jλ/4)×0.95<n₃d₃<(jλ/4)×1.05 relation (3-1)

The higher refractive index, the medium refractive index and the lower refractive index described herein indicate relative magnitudes among the refractive indexes of the layers. Also in the layered structure of FIG. 1B, the higher refractive index layer is utilized as an optical interference layer, whereby an antireflection film with an extremely excellent antireflective property can be obtained.

(Lower Refractive Index Layer)

A lower refractive index layer of the invention will be explained in the following.

In a antireflection film of the invention, the lower refractive index layer preferably has a refractive index within a range of 1.20 to 1.47, and more preferably within a range of 1.30 to 1.44.

Also the lower refractive index layer preferably satisfies the following relation (3) in order to achieve a low reflectance:

(jλ/4)×0.7<n₃d₃<(jλ/4)×1.3 relation (3)

wherein j indicates a positive odd number; n₃ and d₃ respectively represent a refractive index and a film thickness (nm) of the lower refractive index layer as explained above; and λ indicates a wavelength within a range of 500 to 550 nm.

Meeting the relation (3) means that j (positive odd number, usually 1) satisfying the relation (3) exists within the aforementioned wavelength range.

A lower refractive index layer in the invention contains a fluorine-containing polymer which includes at least one each of a fluorine-containing vinyl monomeric polymerization unit (a first polymerization unit derived from a fluorine-containing vinyl monomer) and a hydroxyl group-containing vinyl monomeric polymerization unit (a second polymerization unit derived from a hydroxyl group-containing vinyl monomer), of which a main chain is formed solely of carbon atoms and in which a content of the hydroxyl group-containing vinyl monomeric polymerization unit exceeds 20 mole % with respect to the fluorine-containing polymer, and a compound having a polysiloxane structure.

In the following, the fluorine-containing polymer will be explained in detail.

(Fluorine-Containing Polymer)

(Fluorine-Containing Vinyl Monomeric Polymerization Unit)

In the invention, a fluorine-containing vinyl monomeric polymerization unit, contained in the fluorine-containing polymer to be employed in forming the lower refractive index layer, is not particularly restricted in the structure, and may be, for example, a polymerization unit based on a fluorine-containing olefin, a perfluoroalkyl vinyl ether, a vinyl ether having a fluorine-containing alkyl group, or a (meth)acrylate. In consideration of matching in manufacturing process and properties required for the lower refractive index layer such as the refractive index and the film strength, the fluorine-containing polymer is preferably a copolymer of a fluorine-containing olefin and a vinyl ether, and more preferably a copolymer of a perfluoroolefin and a vinyl ether. Also it may contain, as a copolymerizing component for the purpose of reducing the refractive index, a perfluoroalkyl vinyl ether, a vinyl ether having a fluorine-containing alkyl group, or a (meth)acrylate.

The perfluoroolefin preferably contains 3 to 7 carbon atoms, and is preferably perfluoropropylene or perfluorobutylene in consideration of polymerization reactivity, and particularly preferably perfluoropropylene in consideration of availability.

In the polymer, perfluoroolefin represents a content of from 25 to 75 mole %. A higher content of perfluoroolefin is desirable for obtaining a lower refractive index in the material, but, in consideration of polymerization reactivity, the content is limited at about from 50 to 70 mole % and a higher content is difficult to realize in an ordinary radical polymerization reaction in solution. In the invention, the content is preferably from 30 to 70 mole %, more preferably from 30 to 60 mole %, further preferably from 35 to 60 mole % and particularly preferably from 40 to 60 mole %.

In the invention, a perfluorovinyl ether represented by the following formula MN may be copolymerized for obtaining a lower refractive index. Such copolymerization component may be introduced into the polymer within a range of from 0 to 40 mole %, preferably from 0 to 30 mole % and more preferably from 0 to 20 mole %.

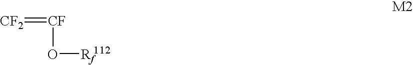

In the formula M2, Rf¹¹² represents a fluorine-containing alkyl group containing 1 to 30 carton atoms, preferably containing 1 to 20 carbon atoms, and particularly preferably containing 1 to 10 carbon atoms, and further preferably a perfluoroalkyl group containing 1 to 10 carbon atoms. Also the fluorine-containing alkyl group may have a substituent. Specific examples of Rf¹¹² include —CF₃ {M2-(1)}, —CF₂CF₃ {M2-(2)}, —CF₂CF₂CF₃ {M2-(3)}, and —CF₂CF(OCF₂CF₂CF₃)CF₃ {M2-(4)}.

(Hydroxyl Group-Containing Vinyl Monomeric Polymerization Unit)

The fluorine-containing polymer to be employed in the invention is required to contain a hydroxyl group-containing vinyl monomeric polymerization unit, with a content thereof over 20 mole %. The content of the hydroxyl group-containing vinyl monomeric polymerization unit is preferably over 20 mol % and no more than 60 mol %, more preferably from 25 to 55 mol %, and still more preferably from 30 mol % to 50 mol %. As the hydroxyl group provides a curing function upon reacting with a crosslinking agent, a higher content of the hydroxyl group is desirable in forming a harder film. However, when the content is too much, the refractive index of the film possibly become higher.

The hydroxyl group-containing vinyl monomer may be employed without any particular restriction as long as it is capable of copolymerization with the aforementioned fluorine-containing vinyl monomeric polymerization unit, and may be, for example, a vinyl ether, a (meth)acrylate or a styrene. For example, in case of utilizing a perfluoroolefin (such as hexafluoropropylene) as the fluorine-containing monomer, it is preferable to employ a hydroxyl group-containing vinyl ether with satisfactory copolymerizing property, such as 2-hydroxyethyl vinyl ether, 4-hydroxybutyl vinyl ether, 6-hydroxyhexyl vinyl ether, 8-hydroxyoctyl vinyl ether, diethylene glycol vinyl ether, triethylene glycol vinyl ether or 4-(hydroxymethyl)cyclohexylmethyl vinyl ether, but these are not restrictive.

In the invention, a fluorine-containing vinyl ether represented by the following formula M1 may be copolymerized for obtaining a lower refractive index. Such copolymerization component may be introduced into the polymer within a range of from 0 to 40 mole %, preferably from 0 to 30 mole % and more preferably from 0 to 20 mole %.

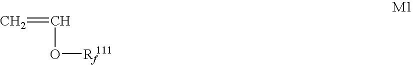

In the formula M1, Rf¹¹¹ represents a fluorine-containing alkyl group which contains 1 to 30 carton atoms, preferably containing 1 to 20 carbon atoms, and particularly preferably containing 1 to 15 carbon atoms, which may have a linear structure {such as CF₂CF₃, —CH₂(CF₂)₄H, —CH₂(CF₂)₈CF₃, or —CH₂CH₂(CF₂)₄H}, a branched structure {such as —CH(CF₃)₂, —CH₂CF(CF₃)₂, —CH(CH₃)CF₂CF₃ or —CH(CH₃)(CH₂)₅CF₂H}, an alicyclic structure (preferably 5- or 6-membered cyclic structure, such as a perfluorocyclohexyl group, a perfluorocyclopentyl group or an alkyl group substituted therewith), or an ether bond (such as —CH₂OCH₂CF₂CF₃, —CH₂CH₂OCH₂C₄F₈H, —CH₂CH₂OCH₂C₆F₁₂H, —CH₂CH₂OCH₂CH₂C₄F₉, —CH₂CH₂OCH₂CH₂C₆F₁₃, or —CH₂CH₂OCF₂CF₂OCF₂CF₂H).

Such monomer represented by the formula M1 can be synthesized, for example, as described in Macromolecules, vol 32(21), p. 7122 (1999) and JP-A-2-721, by a method of reacting a fluorine-containing alcohol in the presence of a base catalyst with an alkyl vinyl ether substituted with a releasable group such as vinyloxyalkyl sulfonate or vinyloxyalkyl chloride; or, as described in WO92/05135, by a method of mixing a fluorine-containing alcohol and a vinyl ether such as butyl vinyl ether in the presence of a palladium catalyst thereby executing a vinyl group exchange; or, as described in U.S. Pat. No. 3,420,793, by a method of reacting a fluorine-containing ketone and dibromoethane in the presence of potassium fluoride catalyst and then executing an HBr extraction reaction by an alkali catalyst.

Preferred examples of the component represented by the formula M1 are illustrated below:

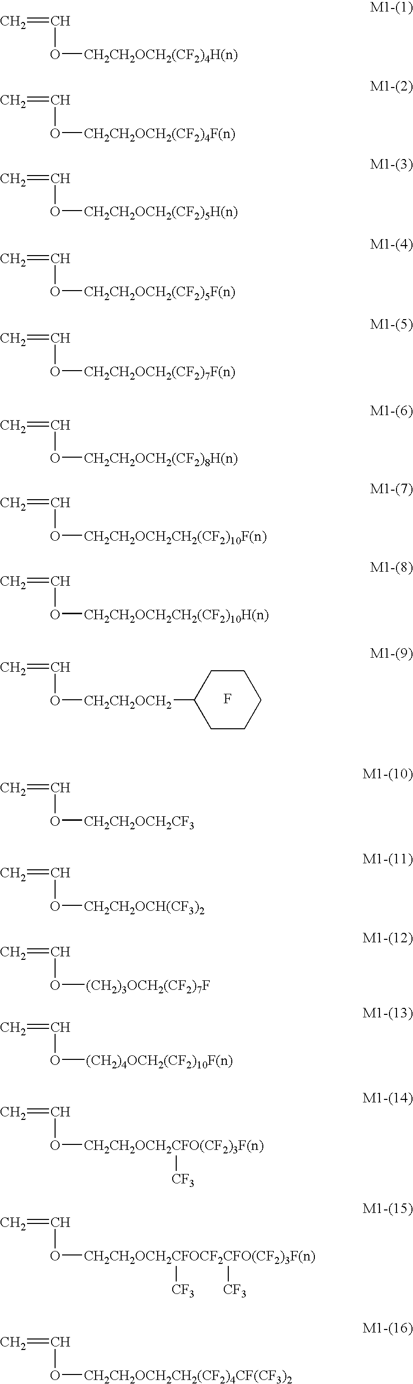

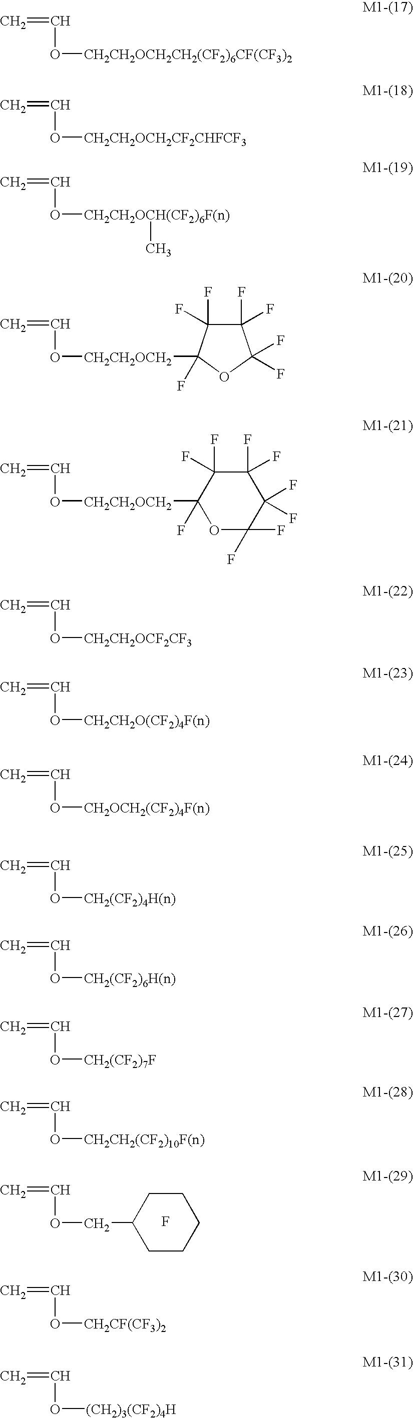

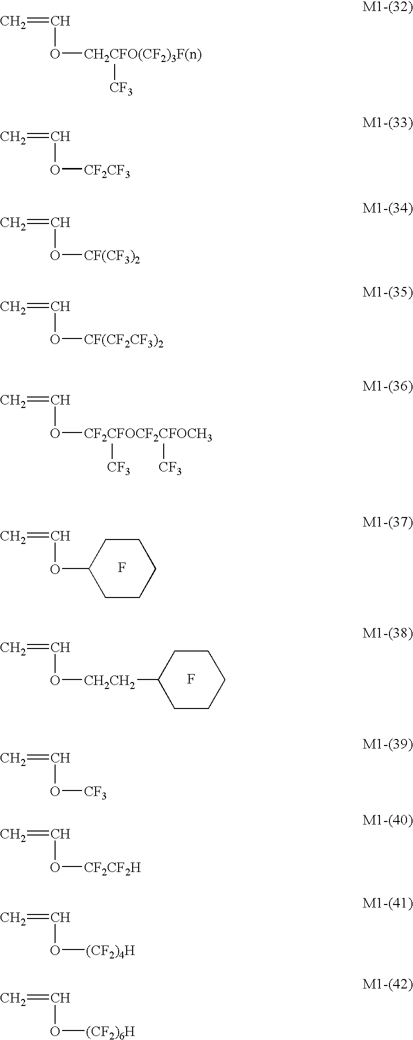

(Other Polymerization Units)

A copolymerizing component constituting other polymerization units may be suitably selected in view of various properties such as a hardness, an adhesion to the substrate, a solubility in a solvent and a transparency, and examples include a vinyl ether such as methyl vinyl ether, ethyl vinyl ether, t-butyl vinyl ether, n-butyl vinyl ether, cyclohexyl vinyl ether, or isopropyl vinyl ether, and a vinyl ester such as vinyl acetate, vinyl propionate, vinyl butyrate, or vinyl cyclohexanecarboxylate. Such copolymerizing component is introduced in an amount within a range of from 0 to 40 mole %, preferably within a range of from a to 30 mole % and particularly preferably within a range of from 0 to 20 mole %.

(Preferred Form of Fluorine-Containing Polymer)

In the invention, a particularly preferred form of the fluorine-containing polymer is represented by a formula (1):

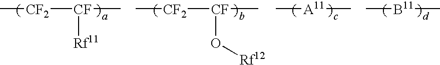

In the formula (1), Rf¹¹ represents a perfluoroalkyl group containing 1 to 5 carbon atoms. On a monomer constituting a part represented by —CF₂CF(Rf¹¹)—, examples of perfluoroolefin described above are applicable. In the formula (1), Rf¹² has a definition same as that described for the fluorine-containing vinyl ether (Rf¹¹² in the compound represented by the formula M2), and has a same preferable range. A¹ and B¹¹ each represent a hydroxyl group-containing vinyl monomeric polymerization unit, and an arbitrary constituent unit. A¹¹ is defined same as the hydroxyl group-containing vinyl monomeric polymerization unit described above, while B¹¹ is not particularly restricted, but, in consideration of the copolymerizing property, is preferably a vinyl ether or a vinyl ester. Specific examples include monomers explained above (as other polymerization units) and monomers represented by the formula M1 above.

a to d represent molar ratios (%) of the respective constituents, and respectively satisfy relations 30≦a≦70 (more preferably 30≦a≦60 and further preferably 35≦a≦60), 0≦b≦40 (more preferably 0≦b≦30 and further preferably 0≦b≦20), 20<c≦70 (more preferably 20<c≦60, further preferably 25≦c≦55 and particularly preferably 30≦c≦50), and 0≦d≦40 (more preferably 0≦d≦30).

The fluorine-containing polymer to be employed for forming the lower refractive index layer of the invention has a number-average molecular weight preferably within a range of 5,000-1,000,000, more preferably 8,000-500,000 and particularly preferably 10,000-100,000.

Specific examples of the polymer, useful in the present invention, are shown in Tables 1 and 2, but the present invention is not limited to such examples.

In Tables 1 and 2, the polymer is represented by a combination of polymerization units.

TABLE 1

| | | fluorine-containing polymer | | | | | | | | | | |
|---|---|---|---|---|---|---|---|---|---|---|---|---|
| | | P1 | P2 | P3 | P4 | P5 | P6 | P7 | P8 | P9 | P10 | P11 |
| fluorine- | HFP | 50 | 50 | 50 | 50 | 45 | 40 | 50 | 50 | 50 | 50 | 50 |
| containing | M1-(1) | | 10 | | | | | 15 | | 10 | | |
| polymer | M1-(5) | | | | | | | | 5 | | | |
| constituent | M2-(3) | | | | | 5 | 10 | | | | | |
| (molar ratio) | HEVE | 50 | 40 | 40 | 45 | 35 | | | | | | |
| (%) | HBVE | | | | | | 25 | 35 | 40 | 40 | | |
| | HOVE | | | | | | | | | | 30 | 35 |
| | DEGVE | | | | | | | | | | | |
| | HMcHVE | | | | | | | | | | | |
| | EVE | | | 10 | | | 25 | | | | | |
| | cHVE | | | | 5 | | | | | | 20 | |
| | tBuVE | | | | | 15 | | | | | | |
| | VAc | | | | | | | | 5 | | | 15 |

| | | | | | | | | | | | |
|---|---|---|---|---|---|---|---|---|---|---|---|
| number-average mol. wt. | 1.5 | 1.8 | 2.3 | 3.5 | 1.3 | 2.2 | 2.8 | 3.5 | 4.5 | 4.2 | 1.9 |
| (×10,000) | | | | | | | | | | | |

TABLE 2

| | | fluorine-containing polymer | | | | | | | | | | |
|---|---|---|---|---|---|---|---|---|---|---|---|---|
| | | P12 | P13 | P14 | P15 | P16 | P17 | P18 | P19 | P20 | P21 | P22 |
| fluorine- | HFP | 50 | 50 | 40 | 50 | 45 | 50 | 50 | 50 | 50 | 40 | 50 |
| containing | M1-(1) | | 5 | | 10 | | | | | | | |
| polymer | M1-(5) | | | | | | | | | | 10 | |
| constituent | M2-(3) | | | 10 | | 5 | | | | | | |
| (molar ratio) | HEVE | | | | | | | | | | | |
| (%) | HBVE | | | | | | | | | | | |
| | HOVE | 40 | 35 | | | | | | | | | |
| | DEGVE | | | 40 | 25 | 35 | 30 | | | | | |
| | HMcHVE | | | | | | | 40 | 30 | 25 | 35 | 50 |
| | EVE | 10 | | 10 | | | | 10 | 5 | | | |
| | cHVE | | | | | | 20 | | 15 | | | |
| | tBuVE | | 10 | | 15 | | | | | 10 | 15 | |
| | VAc | | | | | 15 | | | | 15 | | |

| | | | | | | | | | | | |
|---|---|---|---|---|---|---|---|---|---|---|---|
| number-average mol. wt. | 3.7 | 2.8 | 3.1 | 7.1 | 10 | 2.9 | 3.5 | 1.7 | 2.9 | 2.2 | 1.5 |
| (×10,000) | | | | | | | | | | | |

Abbreviations in the tables have following meanings:

HFP: hexafluoropropylene
HEVE: 2-hydroxyethyl vinyl ether
HBVE: 4-hydroxybutyl vinyl ether
HOVE: 8-hydroxyoctyl vinyl ether
DEGVE: diethylene glycol vinyl ether
HMcHVE: 4-(hydroxymethyl)cyclohexylmethyl vinyl ether
EVE: ethyl vinyl ether
cHVE: cyclohexyl vinyl ether
tBuVE: t-butyl vinyl ether
VAc: vinyl acetate

The fluorine-containing polymer represented by the formula (1) of the invention can be synthesized by various polymerizing processes, such as solution polymerization, sedimentation polymerization, suspension polymerization, bulk polymerization or emulsion polymerization, in already known operation methods, such as a batch operation, a semi-continuous operation or a continuous operation.

The polymerization may be initiated for example by a method utilizing a radical initiator, or a method of irradiating with a light or a radiation. Such polymerization methods and the polymerization initiating methods are described, for example, in Teiji Tsuruta, Kobunshi Gosei-ho (Polymer Synthesizing Methods) (Nikkan Kogyo Shimbun, 1971), and Takayuki Otsu & Masayoshi Konoshita, Kobunshi Gosei-no Jikkenho (Experiments on Polymer Synthesis) Kagaku-Dojin, 1972, p. 124-154.

Among the polymerization methods mentioned above, a solution polymerization utilizing a radical initiator is particularly preferable. A solvent employed in the solution polymerization may be various organic solvents such as ethyl acetate, butyl acetate, acetone, methyl ethyl ketone, methyl isobutyl ketone, cyclohexanone, tetrahydrofuran, dioxane, N,N-dimethylformamide, N,N-dimethylacetamide, benzene, toluene, acetonitrile, methylene chloride, chloroform, dichloroethane, methanol, ethanol, 1-propanol, 2-propanol and 1-butanol, which may be employed singly or as a mixture of two or more kinds, or as a mixed solvent with water.

A polymerization temperature is to be selected in relation with a molecular weight of the polymer to be generated and a type of the initiator, and may be selected within a range of from 0 to 100° C., but the polymerization is preferably executed within a range of from 40 to 100° C.

A reaction pressure may be selected suitably, but is usually from 0.01 to 10 MPa, preferably from 0.05 to 5 MPa and more preferably from 0.1 to 2 MPa. A reaction time is about from 5 to 30 hours.

An obtained polymer may be utilized for the purpose of the present invention in a state of a reaction liquid, or after a purification by a reprecipitation or by a phase separating operation.

(Compound Having Polysiloxane Structure)

In the following, the compound having a polysiloxane structure will be explained.

In the invention, a compound having a polysiloxane structure is utilized for the purpose of improving the scratch resistance and providing the stain resistance. The compound is not restricted in the structure, and an example is a compound including a plurality of a dimethylsilyloxy unit as a repeating unit and having a substituent in a terminal end and/or in a side chain of the chain structure of the compound. Also the chain structure of the compound, including dimethylsilyloxy groups as the repeating unit, may include a structural unit other than the dimethylsilyloxy group.

In the compound having the polysiloxane structure, a molecular weight is not particularly restricted, but is preferably 100,000 or less, particularly preferably 50,000 or less and most preferably from 3,000 to 30,000.

In view of preventing a transfer, the compound preferably includes a hydroxyl group, a functional group capable of forming a bond by reacting with a hydroxyl group, or a functional group capable of forming a bond by reacting with a crosslinking agent described below, which is capable with a hydroxyl group. Such bond forming reaction is preferably one that proceeds rapidly under a heating condition and/or in the presence of a catalyst. Examples of a substituent (functional group) forming a bond by reacting with a hydroxyl group include an epoxy group and a carboxyl group. Examples of a functional group forming a bond by reacting with a crosslinking agent include a amino group. Examples of the preferable compound include those shown in the following, but the present invention is not limited to these examples.

(Compounds Including Hydroxyl Group)

X-22-160AS, KF-6001, KF-6002, KF-6003, X-22-170DX, X-22-176DX, X-22-176D and X-22-176F (the foregoing manufactured by Shin-etsu Chemical Co.); FM-4411, FM-4421, FM-4425, FM-0411, FM-0421, FM-0425, DM-DA11, FM-DA21, and FM-DA25 (the foregoing manufactured by Chisso Corp.); CMS-626 and CMS-222 (the foregoing manufactured by Gelest Inc.).

(Compounds Including Epoxy Group and Carboxyl Group)

X-22-162C and KF-105 (the foregoing manufactured by Shin-etsu Chemical Co.); FM-5511, FM-5521, FM-5525, FM-6611, FM-6621 and FM-6625 (the foregoing manufactured by Chisso Corp.).

(Compound Including Amino Group)

KF-8010, X-22-161A, X-22-161B and KF-105 (the foregoing manufactured by Shin-etsu Chemical Co.); DMS-A15, DMS-A11, DMS-A32, AMS-132, AMS-152, AMS-162, AMS-242, ATM-1112 and ATM-1322 (the foregoing manufactured by Chisso Corp.).

The compound having the polysiloxane structure is preferably added in an amount of from 0.01 to 20 wt % with respect to the fluorine-containing polymer, more preferably from 0.05 to 15 wt %, and further preferably from 0.1 to 10 wt %.

(Curing Agent)

The lower refractive index layer of the invention is preferably formed with a curable composition including a fluorine-containing polymer containing a hydroxyl group, a compound having a polysiloxane structure and a compound (curing agent) capable of reacting with the hydroxyl group of the fluorine-containing polymer, namely so-called curable resinous composition. The curing agent preferably includes two or more sites capable of reacting with the hydroxyl group, and more preferably four or more of such sites.

The curing agent is not particularly restricted in the structure as long as the functional group capable of reacting with the hydroxyl group is contained in the aforementioned number, and examples include a polyisocyanate, a partial condensate or a polymer of an isocyanate compound, an addition product thereof with a polyhydric alcohol or a low molecular weight polyester film, a blocked polyisocyanate in which an isocyanate group is blocked with a blocking agent such as phenol, an aminoplast, a polybasic acid and an anhydride thereof.

In the invention, among these, aminoplasts are preferable in achieving a stability in storage and a reactivity in the crosslinking reaction at the same time. The aminoplast is a compound containing an amino group which is capable of reacting with a hydroxyl group present in the fluorine-containing polymer and which may be a hydroxyalkylamino group or an alkoxyalkylamino group, or a carbon atom which is adjacent to a nitrogen atom and which is substituted with an alkoxy group. Specific examples include melamine-type compounds, urea-type compounds and benzoguanamine-type compounds.

The melamine-type compound is generally known as a compound having a skeleton in which a nitrogen atom is bonded to a triazine ring, and specific examples include melamine, alkylated melamine, methyrolated melamine and alkoxylated melamine. In particular, methyrolated melamine and alkoxylated melamine, that can be obtained by reacting melamine and formaldehyde under a basic condition, and derivatives thereof are preferable, and alkoxylated melamine is particularly preferable because of storage stability. Also methyrolated melamine and alkoxylated melamine are not particularly restricted, and various resins are usable such as those obtained by processes described in “Plastic Zairyou Kouza (8) Urea-melamin resins” (published by Nikkan Kogyo Shimbun).

Among the urea-type compounds recited above, in addition to urea, a polymethyrolated urea, an alkoxylated methylurea which is a derivative thereof, and compounds having a glycoluryl skeleton which is a cyclic urea structure or having a 2-imidazolidinone structure are also preferable. Also as the amino compounds such as the urea derivative recited above, various resins described for example in “Urea-melamin resins” above may be utilized.

In the invention, as an advantageously usable crosslinking agent, a melamine compound or a glycoluryl compound is preferable in consideration of the mutual solubility with the fluorine-containing copolymer, and, in consideration of the reactivity among these, the crosslinking agent is preferably a compound including a nitrogen atom in the molecule and two or more carbon atoms each adjacent to the nitrogen atom and substituted with an alkoxy group. A particularly preferable compound is a compound of a structure represented by following formulas H-1 and H-2, or a partial condensate thereof, wherein R represents an alkyl group containing 1 to 6 carbon atoms or a hydroxyl group.

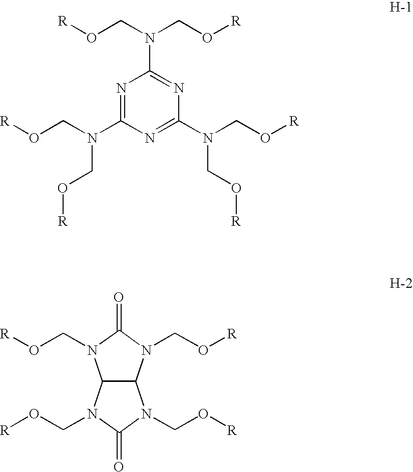

The aminoplasti is added to the fluorine-containing polymer in an amount of from 1 to 50 parts by weight, preferably from 3 to 40 parts by weight and further preferably from 5 to 30 parts by weight, with respect to 100 parts by weight of copolymer. An amount equal to or larger than 1 part by weight provides a sufficient durability in the thin film characterizing the present invention, and an amount equal to or less than 50 parts by weight allows, in an optical application, to maintain a lower refractive index characterizing the lower refractive index layer of the invention. In view of maintaining a lower refractive index even with the addition of the curing agent, there is preferred a curing agent showing little increase in the refractive index upon addition, and, among the compounds recited above, the compound having the skeletal structure H-2 is more preferable.

As the curing is promoted by an acid catalyst, it is preferable to add an acidic substance to the curable resinous composition. In order to realize a stability in storage and a curing activity at the same time, it is more preferable to add a compound capable of generating an acid under heating and/or light irradiation.

The compound capable of generating an acid under heating, namely a thermal acid generator, is a substance allowing, in case of curing a coated film or the like of the curable resinous composition by heating, to employ a milder heating condition.

Specific examples of the thermal acid generator include aliphatic sulfonic acids and salts thereof aliphatic carboxylic acid such as citric acid, acetic acid, and maleic acid and salts thereof; aromatic carboxylic acids such as benzoic acid and phthalic acid, and salts thereof; alkylbenzenesulfonic acids and ammonium salts thereof; metal salts; and esters of phosphoric acid and organic acids. Such thermal acid generator is preferably used, with respect to 100 parts by weight of the fluorine-containing polymer in the curable resinous composition, in an amount of from 0 to 10 parts by weight and more preferably from 0.1 to 5 parts by weight. The thermal acid generator, employed in an amount equal to or less than the aforementioned upper limit, advantageously does not induce detriments such as a deterioration in the storage stability of the curable resinous composition.

The compound capable of generating an acid under a light irradiation, namely a photosensitive acid generator, that can be incorporated in the curable resinous composition of the invention, is a substance that provides the coated film of the curable resinous composition with a photosensitivity, thereby enabling a photocuring thereof by an irradiation with a radiation such as light. Examples of such photosensitive acid generator include (1) onium salts such as an iodonium salt, a sulfonium salt, a phosphonium salt, a diazonium salt, an ammonium salt, and pyridinium salt; (2) sulfon compounds such as a β-ketoester, a β-sulfonylsulfon and an α-diazo compound thereof, (3) sulfonate esters such as an alkylsulfonate ester, a haloalkylsulfonate ester, an arylsulfonate ester and an iminosulfonate; (4) sulfonimide compounds represented by the following formula (2); (5) diazomethane compounds represented by the following formula (3); among others.

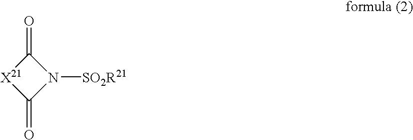

In the formula (2), X²¹ represents a divalent group such as an alkylene group, an arylene group, or an alkoxylene group; and R²¹ represents a monovalent group such as an alkyl group, an aryl group, a halogen-substituted alkyl group or a halogen-substituted aryl group.

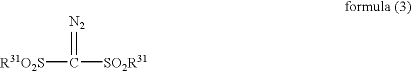

In the formula (3), R³¹ may be mutually the same or different, and each represents a monovalent group such as an alkyl group, an aryl group, a halogen-substituted alkyl group or a halogen-substituted aryl group.

The photosensitive acid generator may be employed singly or in a combination of two or more kinds, or also employed in combination with the thermal acid generator described above. The photosensitive acid generator is preferably employed, with respect to 100 parts by weight of the fluorine-containing polymer in the curable resinous composition, in an amount of from 0 to 20 parts by weight and more preferably from 0.1 to 10 parts by weight. The photosensitive acid generator, employed in an amount equal to or less than the aforementioned upper limit, advantageously provides an excellent strength and a satisfactory transparency in the obtained cured film.

In the invention, in the lower refractive index layer, it is also preferable to add, in the curable resinous composition, inorganic fine particles and an organosilane compound to be explained later.

(Inorganic Particles for Lower Refractive Index Layer)

In the lower refractive index layer, the inorganic particles are preferably blended in an amount of from 1 to 100 mg/m², more preferably in an amount of from 5 to 80 mg/m², and further preferably in an amount of from 10 to 60 mg/m². The organic particles, blended with an amount equal to or higher than the aforementioned lower limit, provide an evident effect of improving the scratch resistance, and, blended with an amount equal to or lower than the aforementioned upper limit, form minute surface irregularities on the surface of the lower refractive index layer, thereby avoiding detriments such as deteriorations in a black image density and an integral reflectance, whereby the blending amount is preferably within the above-recited range.

The inorganic particles, to be contained in the lower refractive index layer, preferably have a lower refractive index, and examples thereof include fine particles of magnesium fluoride and silica, and fine particles of silica are preferable in consideration of the refractive index, the stability of dispersion and the cost.

Such inorganic particles have a particle size preferably within a range of from 1 to 200 nm, and more preferably from 5 to 90 mm. The organic particles, having a particle size equal to or larger than the aforementioned lower limit, provide an evident effect of improving the scratch resistance, and, having a particle size equal to or smaller than the aforementioned upper limit, form minute surface irregularities on the surface of the lower refractive index layer, thereby avoiding detriments such as deteriorations in a black image density and an integral reflectance, whereby the particle size is preferably within the above-recited range.

The inorganic particles may be in a crystalline or amorphous state, and may be constituted of mono-dispersion particles or even agglomerated particles as long as the requirement for the particle size is met. The particles most preferably have a spherical shape, but amorphous-shaped particles are also acceptable.

(Organosilane Compound)

In the invention, the lower refractive index layer may also be formed from a curable composition which further includes an organosilane compound. The organosilane compound has a definition and a preferable compound structure as disclosed in JP-A-2004-331812, paragraphs (0059)-(0085).

(Other Substances Contained in Curable Resinous Composition)

In the antireflection film of the invention, the curable resinous composition to be employed for forming the lower refractive index layer is prepared by adding, to (A) the fluorine-containing polymer and (B) the compound having the polysiloxane structure described above, if necessary (C) the curing agent, (D) the inorganic particles, (E) the organosilane compound, various additives, a radical polymerization initiator and a cationic polymerization initiator to be explained later, and dissolving these components in a suitable solvent. In the solution, a concentration of the solids is suitably selected according to the purpose of use but is generally within a range of about from 0.01 to 60 wt %, preferably about from 0.5 to 50 wt % and particularly preferably about from 1 to 20 wt %.

In consideration for example of an interfacial adhesion with an underlying layer in direct contact with the lower refractive index layer, it is also possible to add a small amount of a curing agent, such as a polyfunctional (meth)acrylate compound, a polyfunctional epoxy compound, a polyisocyanate compound, an aminoplast, a polybasic acid or an anhydride thereof. Such substance, when added, is added in an amount, with respect to all the solids in the film of the lower refractive index layer, preferably within a range of 30 wt % or less, more preferably within a range of 20 wt % or less and particularly preferably within a range of 10 wt % or less.

Also for the purposes of providing characteristics such as a water resistance and a chemical resistance and improving the stain resistance and the lubricity, it is possible to suitably add, in addition to the aforementioned compound having the polysiloxane structure, an antistain agent, a lubricant and the like constituted of a known silicone compound or a known fluorinated compound. Such additives, in the case of addition, are preferably added within a range of from 0.01 to 20 wt % with respect to the total solids of the curable resinous composition, more preferably within a range of from 0.05 to 10 wt % and particularly preferably within a range of from 0.1 to 5 wt %.

The fluorinated compound is preferably a compound having a fluoroalkyl group. Such fluoroalkyl group preferably contains 1 to 20 carbon atoms, more preferably 1 to 10 carbon atoms, and may have a linear structure {such as —CF₂CF₃, —CH₂(CF₂)₄H, —CH₂(CF₂)₈CF₃, or —CH₂CH₂(CF₂)₄H}, a branched structure {such as —CH(CF₃)₂, —CH₂CF(CF₃)₂, —CH(CH₃)CF₂CF₃ or —CH(CH₃)(CF₂)₅CF₂H}, an alicyclic structure (preferably 5- or 6-membered cyclic structure, such as a perfluorocyclohexyl group, a perfluorocyclopentyl group or an alkyl group substituted therewith), or an ether bond (such as —CH₂OCH₂CF₂CF₃, —CH₂CH₂OCH₂C₄F₈H, —CH₂CH₂OCH₂CH₂C₈F₁₇, or —CH₂CH₂OCF₂CF₂OCF₂CF₂H).

The fluorinated compound preferably further includes a substituent that contributes to a bond formation or a mutual solubility with the film of the lower refractive index layer. Such substituent is preferably present in plural units, which may be the same or different. Preferred examples of the substituent include an acryloyl group, a methacryloyl group, a vinyl group, an aryl group, a cinnamoyl group, an epoxy group, a oxetanyl group, a hydroxyl group, a polyoxyalkylene group, a carboxyl group, and an amino group. The fluorinated compound may also be a polymer or an oligomer with a compound not containing a fluorine atom, and is not particularly restricted in the molecular weight.

In the fluorinated compound, a fluorine atom content is not particularly restricted and is preferably 20 wt % or higher, particularly preferably within a range of from 30 to 70 wt % and most preferably within a range of from 40 to 70 wt %. Preferable examples of the fluorinated compound include R-2020, M-2020, R-3833, M-3833 (trade names; manufactured by Daikin Chemical Industries Ltd.); and Megafac F-171, Megafac F-172, Megafac F-179A and Defensa MCF-300 (trade names; manufactured by Nai-Nippon Ink and Chemicals Inc.), but the invention is not limited to these examples.

In the curable resinous composition for forming the lower refractive index layer, an antidust agent or an antistatic agent such as a known cationic surfactant or a polyoxyalkylene compound may be suitably added, for the purpose of providing an antidust property and an antistatic property. Such antidust agent or antistatic agent may be incorporated as a part of the structural units of the silicone compound or the fluorinated compound described above.

These substances, in the case of addition as additives, are preferably added within a range of from 0.01 to 20 wt % with respect to all the solids in the curable resinous composition, more preferably within a range of from 0.05 to 10 wt % and particularly preferably within a range of from 0.1 to 5 wt %.

Preferable examples of the substances include Megafac F-150 (trade name; manufactured by Dai-Nippon Ink and Chemicals Inc.) and SH-3748 (trade name, manufactured by Toray-Dow Corning Co.), but the present invention is not limited to these examples.

(Solvent)

In the invention, as a solvent to be employed in a coating liquid for forming the lower refractive index layer (curable resinous composition), various solvents may be selected in consideration of aspects of dissolving or dispersing the components, easily forming a uniform surface in the coating and drying steps, securing a storability of the liquid, and having an appropriate saturated vapor pressure. The solvent is preferably constituted, in consideration of the load in drying, of a solvent having a boiling point of 100° C. or lower under the normal pressure and at the room temperature as a principal component and, for the purpose of regulating the drying speed, of a small amount of a solvent having a boiling point of 100° C. or higher.

Examples of the solvent having a boiling point of 100° C. or lower include a hydrocarbon such as hexane (boiling point 68.7° C.), heptane (98.4° C.), cyclohexane (80.7° C.) or benzene (80.1° C.); a halogenated hydrocarbon such as dichloromethane (39.8° C.), chloroform (61.2° C.), carbon tetrachloride (76.8° C.), 1,2-dichloroethane (83.5° C.), or trichloroethylene (87.2° C.); an ether such as diethyl ether (34.6° C.), diisopropyl ether (68.5° C.), dipropyl ether (90.5° C.), or tetrahydrofuran (66° C.); an ester such as ethyl formate (54.2° C.), methyl acetate (57.8° C.), ethyl acetate (77.1° C.), or isopropyl acetate (89° C.); a ketone such as acetone (56.1° C.), or 2-butanone (methyl ethyl ketone; 79.6° C.); an alcohol such as methanol (64.5° C.), ethanol (78.3° C.), 2-propanol (82.4° C.) or 1-propanol (97.2° C.); a cyano compound such as acetonitrile (81.6° C.) or propionitrile (97.4° C.); and carbon disulfide (46.2°). Among these a ketone or an ester is preferable, and particularly a ketone, in which 2-butanone is particularly preferred.

Examples of solvent with a boiling point of 100° C. or higher include octane (125.7° C.), toluene (110.6° C.), xylene (138° C.), tetrachloroethylene (121.2° C.), chlorobenzene (131.7° C.), dioxane (101.3° C.), dibutyl ether (142.4° C.), isobutyl acetate (118° C.), cyclohexanone (155.7° C.), 2-methyl-4-pentanone % K; 115.9° C.), 1-butanol (117.7° C.), N,N-dimethylformamide (153° C.), N,N-dimethylacetamide (166° C.), and dimethyl sulfoxide (189° C.), among which preferred is cyclohexanone or 2-methyl-4-pentanone.

(Layered Structure of Antireflection Film)

The antireflection film of the invention has, on a transparent base material, a hard coat layer to be explained later, if necessary, and layers are laminated thereon in consideration of the refractive indexes, layer thicknesses, number of layers and order of layers, in such a manner that the reflectance is reduced by an optical interference.

The antireflection film of low reflectance is, in a simplest structure, formed by coating a lower refractive index layer only on a base material. For further reducing the reflectance, an antireflection layer is preferably constituted of a combination of a higher refractive index layer, having a higher refractive index than in the base material, and a lower refractive index layer, having a lower refractive index than in the base material. Examples of such structure include a two-layered structure including higher refractive index layer/lower refractive index layer from the base material side, and a structure including three layers of different refractive indexes, which are laminated in an order of medium refractive index layer (having a refractive index higher than in the base material or the hard coat layer but lower than in the higher refractive index layer)/higher refractive index layer/lower refractive index layer, and structures including an even larger number of antireflective layers are also proposed.

Preferred examples of the layered structure in the antireflection film of the invention are described below. In these structures, the base film serves as a substrate:

base film/lower refractive index layer;

base film/antistatic layer/lower refractive index layer;

base film/antiglare layer/lower refractive index layer;

base film/antiglare layer/antistatic layer/lower refractive index layer;

base film/antistatic layer/antiglare layer/lower refractive index layer,

base film/hard coat layer/antiglare layer/lower refractive index layer;

base film/hard coat layer/antiglare layer/antistatic layer/lower refractive index layer;

base film/hard coat layer/antistatic layer/antiglare layer/lower refractive index layer;

base film/hard coat layer/higher refractive index layer/lower refractive index layer;

base film/hard coat layer/antistatic layer/higher refractive index layer/lower refractive index layer;

base film/hard coat layer/medium refractive index layer/higher refractive index layer/lower refractive index layer;

base film/antiglare layer/higher refractive index layer/lower refractive index layer;

base film/antiglare layer/medium refractive index layer/higher refractive index layer/lower refractive index layer;

base film/antistatic layer/hard coat layer/medium refractive index layer/higher refractive index layer/lower refractive index layer;

antistatic layer/base film/hard coat layer/medium refractive index layer/higher refractive index layer/lower refractive index layer;

base film/antistatic layer/antiglare layer/medium refractive index layer/higher refractive index layer/lower refractive index layer;

antistatic layer/base film/antiglare layer/medium refractive index layer/higher refractive index layer/lower refractive index layer; and

antistatic layer/base film/antiglare layer/higher refractive index layer/lower refractive index layer/higher refractive index layer/Lower refractive index layer.

The layered structure is not limited to these examples as long as it is capable of reducing the reflectance. The higher refractive index layer may be a light diffusing layer without the antiglare property. Also the antistatic layer is preferably a layer containing conductive polymer particles or metal oxide particles (such as ATO or ITO), and may be provided by a coating process or an atmospheric plasma process.

(Film Forming Binder)

In the invention, a film forming composition for forming a layer other than the lower refractive index layer preferably employs, as a principal film forming binder, a compound containing an ethylenic unsaturated group, in consideration of a film strength, a stability of the coating liquid and a productivity of the coated film. The principal film forming binder means a component representing 10 wt % or more of film forming components other than the inorganic particles. It preferably represents 20 to 100 wt % of such film forming components, more preferably 30 to 95 wt %.

Such binder is preferably a polymer including a saturated hydrocarbon chain or a polyether chain as a principal molecular chain, and more preferably a polymer including a saturated hydrocarbon chain. A binder polymer including a saturated hydrocarbon chain as a molecular chain and also including a crosslinked structure is preferably a (co)polymer of a monomer including two or more ethylenic unsaturated groups.

In order to realize a higher refractive index in the formed film, it is preferable to include, in the monomer structure, an aromatic ring or at least an atom selected from a class of halogen atoms other than fluorine, a sulfur atom, a phosphor atom and a nitrogen atom.

Examples of the monomer including two or more ethylenic unsaturated groups include an ester of a polyhydric alcohol and (meth)acrylic acid (such as ethylene glycol (meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate and polyester polyacrylate), vinylbenezene and derivatives thereof (such as 1,4-divinylbenzene, 4-vinylbenzoate-2-acryloylethyl ester, and 1,4-divinylcyclohexanone), a vinylsulfone (such as divinlylsulfone), an acrylamide (such as methylenebisacrylamide), and methacrylamide. The above-recited monomers may be employed in combination of two or more kinds. In the present specification, “(meth)acrylate” means “acrylate or methacrylate”.

Specific examples of the higher refractive index monomer include bis(4-methacryloylthiophenyl) sulfide, vinylnaphthalene, vinylphenyl sulfide, and 4-methacryloxyphenyl-4-methoxyphenyl thiooether. These monomers may also be employed in combination of two or more kinds.

These monomers including the ethylenic unsaturated groups can be polymerized in the presence of a photoradical polymerization initiator or a thermal radical polymerization initiator, by an irradiation with an ionizing radiation or by heating.

Examples of the photoradical polymerization initiator include acetophenones, benzoins, benzophenones, phosphinoxides, ketals, anthraquinones, thioxanthones, azo compounds, peroxides, 2,3-dialkyldione compounds, disulfide compounds, fluoroamine compounds and aromatic sulfoniums.

Examples of the acetophenones include 2,2-diethoxyacetophenone, p-dimethylacetophenone, 1-hydroxydimethyl phenyl ketone, 1-hydroxycyclohexyl phenyl ketone, 2-methyl-4-methylthio-2-morpholinopropiophenone, and 2-benzyl-2-dimethylamino-1-(4-morpholinophenyl)butanone.

Examples of the benzoins include benzoin benzenesulfonate ester, benzoin toluenesulfonate ester, benzoin methyl ether, benzoin ethyl ether and benzoin isopropyl ether.

Examples of the benzophenones include benzophenone, 2,4-dichlorobenzophenone, 4,4-dichlorobenzophenone and p-chlorobenzophenone.

Examples of the phosphinoxides include 2,4,6-trimethylbenzoyl diphenylphosphinoxide.

Also Kazuhiro Takausu, “Latest UV Curing Technology”, p. 159 (published by Technical Information Inst., 1991) describes various examples which can be useful in the invention.

Preferred examples of a commercially available photo-cleavable photoradical polymerization initiator include Irgacure (651, 184, 907) manufactured by Nippon Chiba-Geigy Ltd.

The photopolymerization initiator is preferably employed within a range of from 0.1 to 15 parts by weight, more preferably from 1 to 10 parts by weight, with respect to 100 parts by weight of the polyfunctional monomer.

A photosensitizer may be employed in addition to the photopolymerization initiator. Specific examples of the photosensitizer include n-butylamine, triethylamine, tri-n-butylphosphine, Michler's ketone and thioxanthone.

Examples of the thermal radical initiator include an organic or inorganic peroxide, and an organic azo or diazo compound. Specifically, examples of organic peroxide include benzoyl peroxide, halogenated benzoyl peroxide, lauroyl peroxide, acetyl peroxide, dibutyl peroxide, cumene hydroperoxide, and butyl hydroperoxide; those of inorganic peroxide include hydrogen peroxide, ammonium persulfate and potassium persulfate; those of azo compound include 2-azobisisobutyronitrile, 2-azobispropionitrile and 2-azobiscyclohexanedinitrile; and those of diazo compound include diaminobenzene, and p-nitrobenzene diazonium.

In the invention, a polymer having a polyether as a principal chain may also be employed. It is preferably a ring-opening polymer of a polyfunctional epoxy compound. A ring-opening polymerization of the polyfunctional epoxy compound can be executed by an irradiation with an ionizing radiation or by heating, in the presence of a photoacid generator or a thermal acid generator.

It is also possible to employ a monomer including a crosslinking functional group, instead of or in addition to the monomer having two or more ethylenic unsaturated groups, thereby introducing a crosslinking functional group in the polymer, and, utilizing a reaction of such crosslinking functional group, to introduce a crosslinked structure into the binder polymer.

Examples of the crosslinking functional group include an isocyanate group, an epoxy group, an aziridine group, an oxazoline group, an aldehyde group, a carbonyl group, a hydrazine group, a carboxyl group, a methylol group and an active methylene group. Also vinylsulfonic acid, an acid anhydride, a cyanoacrylate derivative, melamine, etherified methylol, an ester, an urethane or a metal alkoxide such as tetramethoxysilane may be utilized as a monomer for introducing a crosslinked structure. There can also be employed a functional group capable of showing a crosslinking property as a result of a decomposition reaction, such as a block isocyanate group. Thus, in the invention, the crosslinking functional group need not necessarily be a group immediately capable of a reaction but showing a reactivity after a decomposition reaction.

The binder polymer including such crosslinking functional group can form a crosslinked structure by heating after coating.

(Hard Coat Layer)

{Material for Hard Coat Layer}

In the invention, a hard coat layer is preferably provided. The hard coat layer may serve also as an antiglare layer, by adding matting particles, for providing an antiglare property, to the binder. It may also serve as a higher refractive index layer, by an addition of an inorganic filler for attaining a higher refractive index, preventing a shrinkage by crosslinking and realizing a high strength. It may also be formed by adding the “organosilane compound” described for the lower refractive index layer.

(Matting Particles)

The higher refractive index layer may include, for the purpose of providing an antiglare property, matting particles larger than the filler particles and having an average particle size of from 0.1 to 5.0 μm, preferably from 1.5 to 3.5 μm, such as particles of an inorganic compound or resin particles.

A difference between the refractive indexes of the matting particles and the binder is preferably from 0.02 to 0.20, and particularly preferably from 0.04 to 0.10, since an excessively large difference results in a turbidity in the film while an excessively small difference cannot provide a sufficient light diffusing effect. Also an amount of addition of the matting particles to the binder is preferably 3-30 wt % and particularly preferably 5-20 wt %, since, like the refractive index, an excessively large amount results in a turbidity in the film while an excessively small amount cannot provide a sufficient light diffusing effect.

Specific examples of the matting particles preferably include particles of an inorganic compound such as silica particles, or TiO₂ particles; and resin particles such as acryl particles, crosslinked acryl particles, polystyrene particles, crosslinked styrene particles, melamine resin particles, or benzoguanamine resin particles. Among these, crosslinked styrene particles, crosslinked acryl particles, and silica particles are preferred.

The matting particles may have a spherical or amorphous shape.

Two or more kinds of matting particles, having different particle sizes, may be used in combination. In the case of employing two or more kinds of the matting particles, a difference in the refractive index is preferably within a range of from 0.02 to 0.10, and particularly preferably within a range of from 0.03 to 0.7, in order to effectively attain a control of the refractive index by the mixing. It is also possible to provide an antiglare property with the matting particles of a larger particle size and to provide another optical property with the matting particles of a smaller particle size. For example, in the case of applying an optical film on a high-definition display of 133 ppi or higher, it is required to be free from so-called glittering defect in the optical performance. Such glittering phenomenon is caused by a fact that pixels are enlarged or contracted by irregularities (contributing to the antiglare property) present on the film surface, whereby the luminance loses uniformity, but such phenomenon can be significantly alleviated by employing matting particles, smaller than the matting particles providing the antiglare property and having a refractive index different from that of the binder.

The matting particles most preferably has a particle size distribution of single dispersion, and the particles preferably have particle sizes as mutually close as possible. For example by defining a particle having a size larger by 20% or more than an average particle size as a coarse particle, a proportion of such coarse particles is preferably 1% or less of all the particles, more preferably 0.1% or less and further preferably 0.01% or less. Matting particles having such particle size distribution can be obtained by executing a classification after an ordinary synthesizing reaction, and matting particles of a more preferable distribution can be obtained for example by increasing the number of classification or by increasing a level thereof.

Such matting particles are contained in the hard coat layer in such a manner that an amount of the matting particles therein is preferably within a range of from 10 to 1000 mg/m², and more preferably from 100 to 700 mg/m².

A particle size distribution of the matting particles is measured by a Coulter counter method and is converted into a number distribution of the particles.

(Inorganic Filler)

In the hard coat layer, in order to increase the refractive index of the layer and to reduce a shrinkage at curing, there is preferably contained, in addition to the matting particles, an inorganic filler constituted at least of an oxide of a metal selected from a class of titanium, zirconium, aluminum, indium, zinc, tin and antimony and having an average particle size of 0.2 μm or less, preferably 0.1 μm or less and further preferably 0.06 μm or less.

Also in a hard coat layer utilizing higher refractive index matting particles, in order to maintain the layer at a lower refractive index and to increase a difference in the refractive index from the matting particles, it is preferable to employ a silicon oxide as the filler. A preferable particle size is the same as that of the inorganic filler.

Specific examples of the inorganic filler to be employed in the hard coat layer include TiO₂, ZrO₂, Al₂O₃, In₂O₃, ZnO, SnO₂, Sb₂O₃, ITO and SiO₂. TiO₂ and ZrO₂ are particularly preferable in obtaining a higher refractive index.

The inorganic filler may also be preferably subjected, on the surface thereof, to a silane coupling treatment or a titanium coupling treatment, and a surface treating agent having a functional group capable of reacting with the binder is preferably applied to the filler surface.

Such inorganic filler is preferably added in an amount of from 10 to 90% of the entire weight of the hard coat layer, more preferably from 20 to 80% and particularly preferably from 30 to 70%.

Such filler does not cause a light scattering as its particle size is sufficiently smaller than a wavelength of the light, and a dispersion substance formed by dispersing such filler in the binder polymer behaves as an optically uniform medium.

A bulk refractive index of the mixture of the binder and the inorganic filler of the hard coat layer of the invention is preferably within a range of from 1.48 to 2.00, more preferably from 1.50 to 1.80. A refractive index within such range can be realized by suitably selecting types and proportions of the binder and the inorganic filler. Such selection can be easily made by executing an experiment in advance.

In the thus prepared antireflection film of the invention has a haze within a range of from 3 to 70%, preferably from 4 to 60%, and an average reflectance within a region of 450 to 650 nm of 3.0% or less, preferably 2.5% or less. The antireflection film of the invention, having a haze and an average reflectance within the aforementioned ranges, can achieve an antiglare property and an antireflection property of a satisfactory level, without a deterioration in a transmitted image.

(Substrate)

As a transparent substrate for the antireflection film of the invention, a plastic film is preferably employed. Examples of a polymer constituting the plastic film include a cellulose ester (for example triacetyl cellulose or diacetyl cellulose, representatively TAC-TD80U or TD80UF manufactured by Fuji Photo Film Co.), polyamide, polycarbonate, polyester (such as polyethylene terephthalate or polyethylene naphthalate), polystyrene, polyolefin, a norbornene resin (such as Arton (trade name) manufactured by JSR Corp.), and amorphous polyolefin (such as Zeonex (trade name) manufactured by Nippon Zeon Corp.). Among these, triacetyl cellulose, polyethylene terephthalate or polyethylene naphthalate is preferable, and triacetyl cellulose is particularly preferable.

Also a cellulose acylate film substantially free from a halogenated hydrocarbon such as dichloromethane and a producing method thereof are described in detail in the Japan Institute of Invention and Innovation, Laid-open Technical Report (2001-1745, issued Mar. 15, 2001, JIII) (hereinafter abbreviated as Laid-open Technical Report 2001-1745), and cellulose acylates described therein may also be advantageously utilized in the present invention.

(Saponification Process)

The antireflection film of the invention, in the case of being applied to an image display, is provided on an outermost surface of the display for example by forming an adhesive layer on a side. In the case that the transparent substrate of the antireflection film is formed by triacetyl cellulose, since triacetyl cellulose is employed as a protective film for a polarizing layer of a polarizing plate, it is advantageous in cost to utilize the antireflection film of the invention as the protective film.

The antireflection film of the invention, in the case it is provided on the outermost surface of a display for example by forming an adhesive layer on a side, or in the case it is utilized as a protective film of the polarizing plate, is preferably subjected to a saponification process for achieving a sufficient adhesion, after an outermost layer principally constituted of a fluorine-containing polymer is formed on the transparent substrate.

The saponification process is executed by a known method, such as an immersion of the film in an alkali solution for a suitable time. After the immersion in the alkali solution, the film is preferably washed sufficiently with water or immersed in a dilute acid to neutralize the alkali component in order that the alkali component does not remain in the film. The saponification process renders a surface of the transparent substrate, opposite to a side having the outermost layer, hydrophilic.

The hydrophilic surface thus obtained is particularly effective for improving an adhesion property to a polarizer principally constituted of polyvinyl alcohol. Also the hydrophilic surface, retarding deposition of dust particles in the air, hinders inclusion of dust particles between the polarizer and the antireflection film at the adhesion to the polarizer and is therefore effective for preventing a point-shaped defect caused by the dust particle.

The saponification process is preferably executed in such a manner that a surface of the transparent substrate, opposite to the side having the outermost layer, has a contact angle to water of 40° or less, more preferably 30° or less and particularly preferably 20° or less.

A specific method of the saponification process may be selected from following methods (1) and (2). The method (1) is superior in that the process may be executed in the same manner as in the ordinary triacetyl cellulose film, but it saponifies also the surface of the antireflection layer, thus possibly leading to detriments that the film may be deteriorated by an alkaline hydrolysis of the surface and that a stain may be formed by the eventually remaining saponifying solution. In such case, the method (2) is superior though it requires a particular process:

(1) After the antireflection layer is formed on the transparent substrate, the film is immersed at least once in an alkali solution whereby a rear surface of the film is saponified:

(2) Before or after the antireflection layer is formed on the transparent substrate, an alkali solution is coated on a surface of the antireflection film, opposite to a surface thereof bearing the antireflection layer, then heated, and washed with water and/or neutralized whereby the film is saponified only on the rear surface thereof

(Coated Film Forming Method)

The antireflection film of the invention can be prepared by the following method, which however should not be construed as limiting the scope of the invention.

At first a coating liquid containing components for forming each layer is prepared. The coating liquid is coated on a transparent substrate by a dip coating method, an air-knife coating method, a curtain coating method, a roller coating method, a wired-bar coating method, a gravure coating method or an extrusion coating method (see U.S. Pat. No. 2,681,294), and heat dried.

Among these coating methods, a gravure coating method is preferable as it can coat a coating liquid of a low coating amount, such as each layer of the antireflection film, with a uniform thickness. Within the gravure coating method, a microgravure coating method provides a high uniformity in film thickness and is more preferable.

Also a die coating method can coat a coating liquid of a low coating amount with a high uniformity in the thickness, and is preferable because of a relatively easy film thickness control because of a pre-measurement system and for a limited evaporation of the solvent in the coating part.

In an antireflection film including plural layers, two or more layers may be coated simultaneously. A simultaneous coating method is described for example in U.S. Pat. Nos. 2,761,791, 2,941,898, 3,508,947 and 3,526,528, and Yuji Harasaki, Coating Engineering, p. 253, published by Asakura Shoten (1973).

<Polarizing Plate>

A polarizing plate is principally constituted of a polarizer and two protective films sandwiching the same on both sides. The antireflection film of the invention is preferably employed in at least one of the two protective films sandwiching the polarizer on both sides thereof. The antireflection film of the invention, used also as the protective film, allows to reduce the production cost of the polarizing plate. Also the antireflection film of the invention, employed in the outermost layer, allows to provide a polarizing plate which is capable of preventing a reflection of an external light and is excellent in a scratch resistance and a stain resistance.

As the polarizer, there may be utilized an already known polarizer, or a polarizer that is cut out from a web-shaped polarizer of which an absorbing axis is not parallel nor perpendicular to the longitudinal direction.

A web-shaped polarizer of which an absorbing axis is not parallel nor perpendicular to the longitudinal direction can be prepared by the following method. Such polarizer is formed by stretching a continuously supplied polymer film under a tension by holding both edge portions thereof with holding devices, and may be produced by a stretching method of stretching the film by 1.1 to 20.0 times in at least a transversal direction of the film, in which a difference in the longitudinal advancing speed between the holding devices on both edges of the film is 3% or less and in which the advancing direction of the film is bent in a state, where the both edges of the film are supported, in such a manner that the film advancing direction at an exit of the step of supporting both edges of the film is inclined by from 20° to 70° with respect to the substantial stretching direction of the film. a bend angle of 45° is employed preferably in consideration of the productivity.

A stretching method for the polymer film is described in JP-A-2002-86554, paragraph 0020 to 0030.

<Image Display>

The antireflection film of the invention, in the case of being utilized as one of surface protective films for the polarizer, may be advantageously utilized in a liquid crystal display of transmission type, reflective type or semi-transmission type, of various display modes, such as a twisted nematic mode (TN), a super twisted nematic mode (STN), a vertical alignment mode (VA), an in-plain switching mode (IPS), an optically compensatory bend mode (OCB), or an electrically controlled birefringence mode (ECB).

The liquid crystal cell of VA mode includes:

(1) a liquid crystal cell of VA mode of narrow sense in which the rod-shaped liquid crystal molecules are aligned substantially vertically in the absence of a voltage application and aligned substantially horizontally under a voltage application (described in JP-A-2-176625);

(2) a liquid crystal cell (of MVA mode) in which the VA mode is formed in multi domains for expanding the viewing angle (SID97, Digest of tech. papers (preprints) 28 (1997), p. 845);

(3) a liquid crystal cell of an n-ASM mode in which the rod-shaped liquid crystal molecules are aligned substantially vertically in the absence of a voltage application and are aligned in twisted multi domains under a voltage application (described in Japan Liquid Crystal Seminar, preprints 58-59 (1998)); and

(4) a liquid crystal cell of a SURVIVAL mode (reported at LCD International 98).

For the liquid crystal cell of VA mode, a polarizing plate prepared by combining a biaxially stretched triacetyl cellulose film with the antireflection film of the invention is utilized preferably. The biaxially stretched triacetyl cellulose film is preferably prepared by a method described for example in JP-A-2001-249223 and JP-A-2003-170492.

A liquid crystal cell of OCB mode adopts a bent alignment in which the rod-shaped liquid crystal molecules are aligned in substantially opposite directions (in symmetric manner) in upper and lower parts of the liquid crystal cell, as described in U.S. Pat. Nos. 4,583,825 and 5,410,422. Since the rod-shaped liquid crystal molecules are aligned symmetrically, the liquid crystal cell of the bent alignment mode has an optical self-compensating function. For this reason, such liquid crystal mode is also called an OCB (optically compensatory bend) mode. The liquid crystal display of the bent alignment mode has an advantage of a fast response speed.

A liquid crystal cell of ECB mode, in which the rod-shaped liquid crystal molecules are aligned substantially horizontally in the absence of voltage application, is most widely adopted in color TFT liquid crystal displays and described in many references, for example “EL, PDP and LCD displays” (published by Toray Research Center, 2001).

In a liquid crystal display of TN mode or IPS mode, it is particularly preferable, as described in JP-A-2001-100043, to utilize an optical compensation film having a viewing angle expanding effect as one of two protective films on both sides of the polarizer, at a side opposite to that of the antireflection film of the invention, thereby realizing a polarizing plate that shows an antireflective effect and a viewing angle expanding effect within the thickness of a single polarizing plate.

### EXAMPLES

In the following, the present invention will be further clarified by examples, but the present invention is not limited to such examples. In the following examples and synthesis examples “%” indicates % by weight unless specified otherwise.

<Preparation of Antireflection Film>

(Synthesis of Fluorine-Containing Polymer)

### Synthesis Example 1

### Synthesis of Fluorine-Containing Polymer P1

In a stainless steel autoclave of a capacity of 100 ml equipped with an agitator, 40 ml of ethyl acetate, 14.7 g of hydroxyethyl vinyl ether (HEVE) and 0.55 g of dilauryol peroxide were charged, and the interior of the system was evacuated and replaced with nitrogen gas. Then 25 g of hexafluoropropylene (HFP) were introduced into the autoclave, which was then heated to 65° C. The autoclave showed a pressure of 5.4 kg/cm² when the internal temperature reached 65° C. The reaction was continued for 8 hours by maintaining the autoclave at 65° C., then the heating was terminated when the pressure reached 3.2 kg/cm² and the system was let to cool by standing.

When the internal temperature was lowered to the room temperature, the unreacted monomer was expelled and the reaction liquid was taken out by opening the autoclave. The obtained reaction liquid was poured into hexane of a large excess amount, and a precipitated polymer was obtained by decanting the solvent. The polymer was then dissolved in a small amount of ethyl acetate and re-precipitated from hexane twice to completely eliminate the residual monomer. 28 g of a copolymer P1, having an HEP:HEVE molar ratio of 1:1 were obtained after drying. The obtained polymer had a number-average molecular weight of 15,000.

### Synthesis Examples 2 to 6

Fluorine-containing polymers P2, P3, P6, P9 and P20 were synthesized in a similar manner as P1 in the synthesis example 1. The obtained fluorine-containing polymers had number-average molecular weights as shown in the foregoing Tables 1 and 2.

(Preparation of Antireflection Film)

### Examples 1-1 to 1-3 and Comparative Examples 1-1 to 1-6

### Preparation of Coating Liquids (LLL-1 to LLL-30) for Lower Refractive Index Layer

Components shown in Table 3 were mixed and dissolved in 2-butanone to obtain a coating liquid with a solid content of 6% for the lower refractive index layer. A parenthesized figure in Table 3 indicates an amount of solid of each component in parts by weight.

TABLE 3

| | fluorine-containing | | | | | | | | colloidal |
|---|---|---|---|---|---|---|---|---|---|
| coating | polymer | | curing agent | | curing catalyst | | polysiloxane | | silica |
| liquid | No. | (amt.) | type | (amt.) | type | (amt.) | type | (amt.) | (amount) |
| LLL-1 | P1 | (90) | H-a | (10) | PTS | (0.5) | FM-4421 | (2) | |
| LLL-2 | ″ | (80) | ″ | (20) | ″ | (1) | FM-4425 | (1) | |
| LLL-3 | ″ | (90) | H-b | (10) | ″ | (0.5) | X-22-160AS | (1.5) | |
| LLL-4 | ″ | (80) | ″ | (20) | ″ | (1) | CMS-626 | (2) | |
| LLL-5 | ″ | ″ | Cymel 303 | (20) | ″ | (0.5) | FM-4411 | (1) | |
| LLL-6 | ″ | (56) | H-a | (14) | ″ | (1) | X-22-160AS | (1.5) | (30) |
| LLL-7 | ″ | (95) | Takenate | (5) | — | — | FM-DA25 | (1) | |
| | | | D110 | | | | | | |
| LLL-8 | P2 | (90) | H-a | (10) | PTS | (1) | X-22-160AS | (2) | |
| LLL-9 | ″ | (72) | ″ | (8) | ″ | (1) | FM-4421 | (1) | (20) |
| LLL-10 | ″ | ″ | H-b | (8) | ″ | (1.5) | FM-4425 | (1.5) | (20) |
| LLL-11 | ″ | (90) | ″ | (10) | ″ | (0.5) | FM-DA21 | (2) | |
| LLL-12 | ″ | ″ | Cymel 303 | (10) | ″ | ″ | X-22-160AS | (1.5) | |
| LLL-13 | ″ | (63) | ″ | (7) | ″ | ″ | CMS-222 | (1) | (30) |
| LLL-14 | P3 | (90) | H-a | (10) | ″ | (1) | X-22-160AS | (1.5) | |
| LLL-15 | ″ | (80) | ″ | (20) | ″ | (1.5) | FM-4421 | (2) | |
| LLL-16 | ″ | (95) | H-b | (5) | ″ | (1) | FM-DA25 | (1) | |
| LLL-17 | ″ | (72) | ″ | (8) | ″ | (0.5) | FM-4421 | (2) | (20) |
| LLL-18 | ″ | (64) | Cymel 303 | (16) | ″ | (1) | FM-4425 | (1) | (20) |
| LLL-19 | P6 | (90) | H-a | (10) | ″ | (2) | FM-4421 | (2) | |
| LLL-20 | ″ | (80) | H-b | (20) | ″ | ″ | CMS-626 | (1.5) | |
| LLL-21 | ″ | (64) | Cymel 303 | (16) | ″ | (1.5) | X-22-160AS | (1) | (20) |
| LLL-22 | P9 | (90) | H-a | (10) | ″ | (0.5) | CMS-222 | (1) | |
| LLL-23 | ″ | (72) | ″ | (8) | ″ | (1) | FM-DA25 | (2) | (20) |
| LLL-24 | ″ | (85) | H-b | (15) | ″ | (1.5) | CMS-626 | (2) | |
| LLL-25 | ″ | (76.5) | ″ | (8.5) | ″ | (1) | FM-4421 | (1) | (15) |
| LLL-26 | P20 | (80) | H-a | (20) | ″ | ″ | X-22-160AS | (1) | |
| LLL-27 | ″ | (56) | ″ | (14) | ″ | (0.5) | FM-4425 | (1.5) | (30) |
| LLL-28 | ″ | (63) | H-b | (7) | ″ | (1.5) | CMS-222 | (2) | (30) |
| LLL-29 | ″ | ″ | Cymel 303 | (7) | ″ | (1) | X-22-160AS | (1) | (30) |
| LLL-30 | ″ | (56) | ″ | (14) | ″ | (2) | CMS-626 | (2) | (30) |

In the tables following components were used:

colloidal silica: MEK-ST manufactured by Nissan Chemical Ind. Ltd.;

Cymel 303: a methylolated melamin manufactured by Nippon Cytec Industries Ltd.; and

Takenate D110: an isocyanate-based curing agent, manufactured by Takeda Pharmaceutical Co., Ltd.

H-a and H-b respectively represent compounds of following structures, and PTS represents p-toluenesulfonic acid monohydrate.

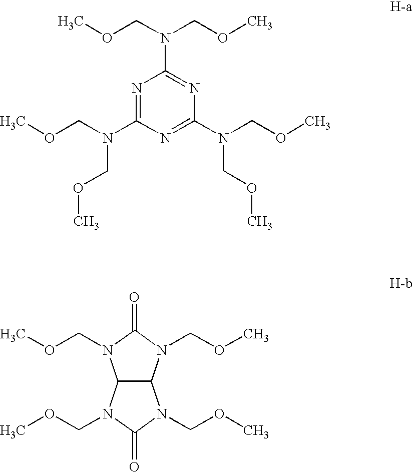

(Preparation of Coating Liquids (LLRL-1 to LLRL-6) for Lower Refractive Index Layer of Comparative Example)

As in the above-described examples, components shown in Table 4 were mixed and dissolved in 2-butanone to obtain a coating liquid with a solid content of 6% for the lower refractive index layer of comparative example. In Table 4, a parenthesized figure indicates an amount of solid of each component in parts by weight, and abbreviations have the same meanings as explained above.

TABLE 4

| | fluorine-containing | | | | | | | | colloidal |
|---|---|---|---|---|---|---|---|---|---|
| coating | polymer | | curing agent | | curing catalyst | | polysiloxane | | silica |
| liquid | No. | (amt.) | type | (amt.) | type | (amt.) | type | (amt.) | (amount) |
| LLRL-1 | P1 | (80) | H-a | (20) | PTS | (1) | — | — | |
| LLRL-2 | ″ | (56) | ″ | (14) | ″ | ″ | — | — | (30) |
| LLRL-3 | PR1 | (80) | ″ | (20) | ″ | ″ | FM-4425 | (1) | |
| LLRL-4 | ″ | (56) | ″ | (14) | ″ | ″ | ″ | ″ | (30) |
| LLRL-5 | PR2 | (80) | ″ | (20) | ″ | ″ | — | — | |
| LLRL-6 | ″ | (56) | ″ | (14) | ″ | ″ | — | — | (30) |

Compounds shown in Table 4 have structures shown in the following chemical formulas, and were synthesized under the same conditions as described in following patent references:

PR1: a copolymer described in Japanese Patent No. 3498481, Example 2;

PR2: a copolymer described in JP-A-2004-307524, Example 6.

In the chemical formulas, numerals represent molar ratios of the monomers, and numerals on a polysiloxane skeleton of PR2 represent weight ratios of the parts of the polysiloxane skeleton.

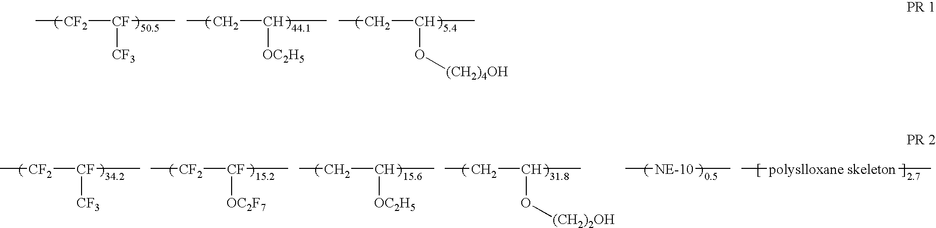

(Preparation of Hard Coat Layer Coating Liquid (HCL-1))

| | |
|---|---|
| PET-30 | 50.0 g |
| Irgacure 184 | 2.0 g |
| SX-350 (30%) | 1.5 g |
| crosslinked acryl-styrene particles (30%) | 13.9 g |
| KBM-5103 | 10.0 g |
| toluene | 38.5 g |

A mixed liquid of the above components was filtered with a polypropylene filter of a pore size of 30 μm to obtain a coating liquid (HCL-1) for the hard coat layer.

The used compounds are explained below:

PET-30: a mixture of pentaerythritol triacrylate and pentaerythritol tetraacrylate (manufactured by Nippon Kayaku Co.);

Irgacure 184: a polymerization initiator (manufactured by Ciba Specialty Chemicals Ltd.);

SX-350: crosslinked polystyrene particles with an average particle size of 3.5 μam (refractive index 1.60, manufactured by Soken Chemical Co., supplied as a 30% dispersion in toluene, and used after a dispersion with a polytron disperser at 10,000 rpm for 20 minutes);

crosslinked acryl-styrene particles: an average particle size of 3.5 μm (refractive index 1.55, manufactured by Soken Chemical Co., supplied as a 30% dispersion in toluene, and used after a dispersion with a polytron disperser at 10,000 rpm for 20 minutes); and

KBM-5103: acryloyloxypropyl trimethoxysilane (manufactured by Shin-etsu Chemical Co.).

(Preparation of Antireflection Film (101))

A triacetyl cellulose film having a thickness of 80 μm (TAC-TD80U, manufactured by Fuji Photo Film Co., Ltd.) in a roll form was unwound as a substrate and was directly coated with the hard coat layer coating liquid described above (HCL-1), utilizing a microgravure roll of a diameter of 50 mm having a gravure pattern of lines of 180 line/inch and a depth of 40 μm and a doctor blade, under a gravure roll revolution of 30 rpm and a transporting speed of 30 m/min, then dried for 150 seconds at 60° C., and irradiated with an ultraviolet light of an illumination intensity of 400 mW/cm² and an illumination amount of 110 mJ/cm² utilizing an air-cooled metal halide lamp of 160 W/cm (manufactured by Eyegraphics Co.) under nitrogen purging with an oxygen concentration of 0.1 vol % to cure the coated layer, thereby obtaining a hard coat layer of a thickness of 6 μm, and the film was thereafter wound again. The hard coat layer (HC-1) thus prepared had a surface roughness of Ra=0.18 μm and Rz=1.40 μm and a haze of 35%.

On thus prepared hard coat layer, the aforementioned coating liquid for lower refractive index layer (LLL-1) was so coated as to obtain a lower refractive index layer of a thickness of 95 nm, thereby obtaining an antireflection film sample (101). The lower refractive index layer was dried under conditions of 120° C., 10 minutes, and the UV curing was conducted with an ultraviolet irradiation of an illumination intensity of 120 mW/cm² and an illumination amount of 240 mJ/cm² utilizing an air-cooled metal halide lamp of 240 W/cm (manufactured by Eyegraphics Co.) under nitrogen purging to obtain an atmosphere with an oxygen concentration of 0.01 vol. % or less.

(Preparation of Antireflection Films (102) to (130) and (R01) to (R08))

Antireflection films (102) to (130) were prepared in the same manner as the antireflection film (101) except that the lower refractive index layer coating liquid (LLL-1) employed therein was replaced respectively by either one of (LLL-2)-(LLL-30). Also comparative antireflection films (R01)-(R-08) were prepared in the same manner as the antireflection film (101) except that the lower refractive index layer coating liquid (LLL-1) employed therein was respectively replaced by either one of (LLRL-2)-(LLRL-8).

(Saponification Treatment of Antireflective Film)

The obtained antireflective film was treated and dried under following standard saponification conditions:

alkali bath: 1.5 mol/dm³ aqueous solution of sodium hydroxide, 55° C., 120 seconds;

first rinsing bath: tap water, 60 seconds;

neutralizing bath: 0.05 mol/dm³ sulfuric acid, 30° C., 20 seconds;

second rinsing bath: tap water, 60 seconds; and

drying: 120° C., 60 seconds.

(Evaluation of Antireflection Film)

The antireflection film thus obtained after saponification was subjected to following evaluations.

(Evaluation 1): Measurement of Average Reflectance

A spectral reflectance at an incident angle of 5° within a wavelength range of 380 to 780 nm was measured with a spectrophotometer V-550 (manufactured by Jasco Corp.) and with an integrating sphere.

A sample prepared as a polarizing plate was evaluated in the form of such polarizing plate, while, in a film itself or a display not utilizing a polarizing plate, a rear surface of the antireflection film was subjected to a light absorbing treatment with a black ink (transmittance of less than 10% within a range of 380 to 780 nm) and a measurement was made on a black table.

(Evaluation 2): Evaluation for Steel Wool Scratch Resistance

A rubbing test was conducted with a rubbing tester under following conditions: evaluating environmental condition: 25° C., 60% RH;

rubbing material: Steel wool (grade No. 0000, manufactured by Nippon Steel Wool Co.) was wound and immovably fixed with a band on a rubbing end (1 cm×1 cm) of the tester, coming into contact with the sample, and a reciprocating rubbing motion was conducted under following conditions:

moving distance (one way): 13 cm, rubbing speed: 13 cm/sec,

load: 200 g/cm², contact area at distal end: 1 cm×1 cm,

number of rubbings: 10 reciprocating cycles.

Oily black ink was coated on a rear side of the sample after rubbing, and scratches in the robbed portion were visually observed under a reflected light and evaluated in following criteria:

A: no scratches observable at all even in a very careful observation;

AB: weak scratches slightly observable in a very careful observation;

B: weak scratches observable;

BC: scratches of medium level observable;

C: scratches readily observable.

(Evaluation 3): Evaluation for Rubber Eraser Rubbing Resistance

A rubbing test was conducted with a rubbing tester under following conditions:

evaluating environmental condition: 25° C., 60% RH;

rubbing material: A plastic eraser (MONO, manufactured by Tombow Pencil Co.) was fixed on a rubbing end (1 cm×1 cm) of the tester, coming into contact with the sample;

moving distance (one way): 4 cm, rubbing speed: 2 cm/sec,

load: 500 g/cm², contact area at distal end: 1 cm×1 cm,

number of rubbings: 100 reciprocating cycles.

Oily black ink was coated on a rear side of the sample after rubbing, and scratches in the rubbed portion were visually observed under a reflected light and evaluated in following criteria:

A: no scratches observable at all even in a very careful observation;

AB: weak scratches slightly observable in a very careful observation;

B: weak scratches observable;

BC: scratches of medium level observable;

C: scratches readily observable;

CC: scratches over all the surface.

(Evaluation 4): Evaluation for Adhesion of Oily Marker Ink

As an index for the stain resistance of the surface, an adhesion of an oily marker ink was evaluated by subjecting the antireflection film to a moisture adjustment for 2 hours under conditions of 25° C. and 60% RH, then attaching the oily marker ink to the sample surface and observing the surface state after wiping off the ink with a cleaning cloth, and the result was evaluated in following criteria:

AA: marker ink completely wiped off;

A: marker ink slightly observable;

B: marker ink a little observable;

C: marker ink scarcely wiped off.

Results of evaluations are shown in Table 5.

TABLE 5

| | Antireflection film | | | | | | |
|---|---|---|---|---|---|---|---|
| | | structure | | characteristics | | | |
| | | hard coat | low ref. index | average | | | |
| | sample | layer coating | layer coating | reflectance | scratch resistance | | oily marker |
| | No. | liquid | liquid | (%) | steel wool | eraser | ink adhesion |
| Example 1-1 | 101 | HCL-1 | LLL-1 | 1.84 | A | A | AA |
| Example 1-2 | 102 | ″ | LLL-2 | 1.86 | A | A | AA |
| Example 1-3 | 103 | ″ | LLL-3 | 1.83 | A | A | AA |
| Example 1-4 | 104 | ″ | LLL-4 | 1.84 | A | A | AA |
| Example 1-5 | 105 | ″ | LLL-5 | 1.85 | A | A | AA |
| Example 1-6 | 106 | ″ | LLL-6 | 1.86 | A | A | AA |
| Example 1-7 | 107 | ″ | LLL-7 | 1.83 | A | A | AA |
| Example 1-8 | 108 | ″ | LLL-8 | 1.84 | A | A | AA |
| Example 1-9 | 109 | ″ | LLL-9 | 1.83 | A | A | AA |
| Example 1-10 | 110 | ″ | LLL-10 | 1.83 | A | A | AA |
| Example 1-11 | 111 | ″ | LLL-11 | 1.82 | A | A | AA |
| Example 1-12 | 112 | ″ | LLL-12 | 1.82 | A | A | AA |
| Example 1-13 | 113 | ″ | LLL-13 | 1.83 | A | A | AA |
| Example 1-14 | 114 | ″ | LLL-14 | 1.84 | A | A | AA |
| Example 1-15 | 115 | ″ | LLL-15 | 1.85 | A | A | AA |
| Example 1-16 | 116 | ″ | LLL-16 | 1.82 | A | A | AA |
| Example 1-17 | 117 | ″ | LLL-17 | 1.84 | A | A | AA |
| Example 1-18 | 118 | ″ | LLL-18 | 1.86 | A | A | AA |
| Example 1-19 | 119 | ″ | LLL-19 | 1.84 | A | A | AA |
| Example 1-20 | 120 | ″ | LLL-20 | 1.83 | A | A | AA |
| Example 1-21 | 121 | ″ | LLL-21 | 1.85 | A | A | AA |
| Example 1-22 | 122 | ″ | LLL-22 | 1.84 | A | A | AA |
| Example 1-23 | 123 | ″ | LLL-23 | 1.85 | A | A | AA |
| Example 1-24 | 124 | ″ | LLL-24 | 1.83 | A | A | AA |
| Example 1-25 | 125 | ″ | LLL-25 | 1.83 | A | A | AA |
| Example 1-26 | 126 | ″ | LLL-26 | 1.84 | A | A | AA |
| Example 1-27 | 127 | ″ | LLL-27 | 1.85 | A | A | AA |
| Example 1-28 | 128 | ″ | LLL-28 | 1.83 | A | A | AA |
| Example 1-29 | 129 | ″ | LLL-29 | 1.86 | A | A | AA |
| Example 1-30 | 130 | ″ | LLL-30 | 1.86 | A | A | AA |
| Comp.Ex. 1-1 | R01 | HCL-1 | LLRL-1 | 1.84 | AB | A | C |
| Comp.Ex. 1-2 | R02 | ″ | LLRL-2 | 1.85 | AB | A | C |
| Comp.Ex. 1-3 | R03 | ″ | LLRL-3 | 1.85 | C | C | B |
| Comp.Ex. 1-4 | R04 | ″ | LLRL-4 | 1.85 | C | B | B |
| Comp.Ex. 1-5 | R05 | ″ | LLRL-5 | 1.84 | C | B | AB |
| Comp.Ex. 1-6 | R06 | ″ | LLRL-6 | 1.84 | B | AB | AB |

As will be apparent from these results, the antireflection film samples (101)-(130) of Examples 1-1 to 1-30 of the invention are superior in the scratch resistance and in the stain resistance, in comparison with the antireflection film samples (R01)-(R06) of Comparative Examples 1-1 to 1-6, which do not meet the requirements of the present invention such as not containing the compound having the polysiloxane structure or having a low hydroxyl group content, and still have an appropriate antireflective performance as an antireflection film.

### Example 2

Following multi-layered antireflection films were prepared.

(Preparation of Coating Liquid (HCL-2) for Hard Coat Layer)

100 parts by weight of Desolite Z7404 (hard coat composition containing zirconia particles manufactured by JSR Corp.), 31 parts by weight of DPHA (ultraviolet curable resin, manufactured by Nippon Kayaku Co.) 10 parts by weight of KBM-5103 (silane coupling agent: manufactured by Shin-etsu Chemical Co.), 29 parts by weight of methyl ethyl ketone MEK), 13 parts by weight of methyl isobutyl ketone (MIBK), and 5 parts by weight of cyclohexanone were charged in a mixing tank and agitated to obtain a coating liquid (HCL-2) for the hard coat layer.

(Preparation of Antireflection Film (201))

A triacetyl cellulose film TD80U, manufactured by Fuji Photo Film Co., Ltd.) in a roll form was unwound as a substrate and was coated with the hard coat layer coating liquid described above (HCL-2), utilizing a microgravure roll of a diameter of 50 mm having a gravure pattern of lines of 135 line/inch and a depth of 60 μm and a doctor blade, under a transporting speed of 10 m/min, then dried for 150 seconds at 60° C., and irradiated with an ultraviolet light of an illumination intensity of 400 mW/cm² and an illumination amount of 100 mJ/cm² utilizing an air-cooled metal halide lamp of 160 W/cm (manufactured by Eyegraphics Co.) under nitrogen purging to cure the coated layer, thereby obtaining a hard coat layer, and the film was thereafter wound again. The hard coat layer was prepared by regulating the revolution of the gravure roll in such a manner that the hard coat layer after curing had a thickness of 4 μm.

On thus prepared hard coat layer, the aforementioned coating liquid for lower refractive index layer (LLL-1) was so coated as to obtain a lower refractive index layer of a thickness of 95 nm, thereby obtaining an antireflection film sample (201). The lower refractive index layer was dried under conditions of 120° C., 12 minutes, and the UV curing was conducted with an ultraviolet irradiation of an illumination intensity of 120 mW/cm² and an illumination amount of 240 mJ/cm² utilizing an air-cooled metal halide lamp of 240 W/cm (manufactured by Eyegraphics Co.) under nitrogen purging to obtain an atmosphere with an oxygen concentration of 0.01 vol % or less.

In evaluations in the same manner as in Example 1, similar effects were confirmed by the use of the lower refractive index layer of the invention.

<Preparation of Polarizing Plate with Antireflection Film>

### Example 3

A polarizer was prepared by adsorbing iodine on a stretched polyvinyl alcohol film. A saponified antireflection film of Example 1 of the invention was adhered with a polyvinyl alcohol-based adhesive onto a side of the polarizer in such a manner that the substrate (triacetyl cellulose) of the antireflection film was positioned at the side of the polarizer. A viewing angle expanding film having an optical compensation layer (Wide View film SA12B, manufactured by Fuji Photo Film Co.) was saponified and adhered, with a polyvinyl alcohol-based adhesive, onto the other side of the polarizer, thereby obtaining a polarizing plate. TI evaluations in the same manner as in Example 1, similar effects were confirmed by the use of the lower refractive index layer of the invention.

<Preparation of Image Display Apparatus>

### Example 4

Each of the samples of Examples 1 and 2, and the sample of polarizing plate of Example 3 was adhered, with an adhesive material, onto a surface glass plate of an organic EL display, thereby providing a display of a high visibility with a reduced reflection on the glass surface.

It will be apparent to those skilled in the art that various modifications and variations can be made to the described embodiments of the invention without departing from the spirit or scope of the invention. Thus, it is intended that the invention cover all modifications and variations of this invention consistent with the scope of the appended claims and their equivalents.

The present application claims foreign priority based on Japanese Patent Application No. JP2005-186934 filed Jun. 27 of 2005, the contents of which are incorporated herein by reference.

1-7. (canceled)

8. An antireflection film comprising:
a transparent substrate; and
a lower refractive index layer containing: a fluorine-containing polymer having a main chain of carbon atoms only; and a compound having a polysiloxane structure,
wherein the fluorine-containing polymer contains a first polymerization unit derived from a fluorine-containing vinyl monomer and a second polymerization unit derived from a hydroxyl group-containing vinyl monomer, and
the fluorine-containing polymer has a content of the second polymerization unit of not less than 20 mole % and
the compound having the polysiloxane structure contains at least one of a hydroxyl group, a functional group capable of forming a bond by reacting with a hydroxyl group, and a functional group capable of forming a bond by reacting with the crosslinking agent.

9. The antireflection film according to claim 8, wherein the fluorine-containing polymer is represented by formula (1): 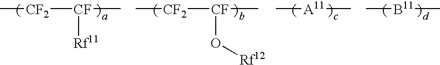
wherein Rf¹¹ represents a perfluoroalkyl group containing 1 to 5 carbon atoms; Rf¹² represents a fluorine-containing alkyl group containing 1 to 30 carbon atoms; A¹¹ represents a polymerization unit derived from a hydroxyl group-containing vinyl monomeric polymerization unit; B¹¹ represents a constituent unit; and a to d each represent molar ratios (%) of the constituents, with values satisfying relations of 30≦a≦70, 0≦b≦40, 20<c≦70 and 0≦d≦40.

10. The antireflection film according to claim 8, wherein the lower refractive index layer further comprises a crosslinking agent capable of reacting with a hydroxyl group.

11. The antireflection film according to claim 8, wherein the crosslinking agent is a compound containing a nitrogen atom in a molecule thereof and having two or more carbon atoms, each of the two or more carbon atoms being adjacent to the nitrogen atom and being substituted with an alkoxy group.

12. A polarizing plate comprising:
a polarizer; and
two protective films,
wherein one of the two protective films is an antireflection film according to claim 8.

13. An image display comprising an antireflection film according to claim 8 or a polarizing plate according to claim 6 in an outermost surface of the display.
